(19) United States
(12) Patent Application Publication
(10) Pub. No.: US 2026/0322654 A1
(43) Pub. Date: Oct. 15, 2026

(54) AUGMENTED MACHINE LEARNING FOR WIRELESS CHANNEL ESTIMATION

(71) Applicant: QUALCOMM Incorporated, San Diego, CA (US)

(72) Inventors: Fabio Valerio MASSOLI, Amsterdam (NL); Christos LOUIZOS, Amsterdam (NL); Arash BEHBOODI, Amsterdam (NL); Joseph Binamira SORIAGA, San Diego, CA (US)

(21) Appl. No.: 19/117,298

(22) PCT Filed: Sep. 18, 2023
(86) PCT No.: PCT/US2023/074485

§ 371 Date: Mar. 31, 2025

(30) Foreign Application Priority Data
Nov. 14, 2022 (GR) 20220100937

(51) Int. Cl. H04L 25/02; H04L 41/16

(52) U.S. Cl. CPC H04L 25/0202; H04L 41/16

(57) ABSTRACT

Certain aspects of the present disclosure provide techniques and apparatus for wireless channel estimation using augmented machine learning models. A first machine learning model generates a set of layer-specific adaptation parameters based on a sensing matrix and a learned sparsifying dictionary. A second machine learning model generates a set of layer-specific sparse vector representations and the learned sparsifying dictionary based on the sensing matrix and the layer-specific adaptation parameters generated by the first machine learning model. A channel estimate is generated (e.g., by the second machine learning model) based on at least one layer-specific sparse vector representation from the generated set of layer-specific sparse vector representations. One or more actions may be taken based on the generated channel estimate.

### CROSS-REFERENCE TO RELATED APPLICATION(S)

This application claims priority to Greek patent application No. 20220100937, entitled “Neurally Augmented Machine Learning for Wireless Channel Estimation,” filed Nov. 14, 2022, and assigned to the assignee hereof, which is incorporated by reference herein in its entirety.

### INTRODUCTION

Aspects of the present disclosure relate to channel estimation using machine learning models.

Wireless communication channels can have a variety of dynamic properties that affect how the signal propagates from the transmitter to the receiver. Such properties are often referred to collectively as channel state information (CSI), and determining or estimating such properties may be referred to as channel estimation. Accurate channel estimation allows for adaptation of wireless transmissions based on channel conditions, which can significantly increase communication reliability and throughput, for example in scenarios where multiple antennas are used for communications between different devices, such as in multiple-input multiple-output (MIMO) systems. However, channel estimation, in many deployments (e.g., millimeter-wave (mmWave or mmW) massive MIMO systems that use analog beamforming), is generally an undetermined problem, or a problem in which there are a sufficient number of unknown parameters such that values may not be conclusively determined for all of these parameters. As a result, channel estimation may often be inaccurate, computationally expensive to perform, or unavailable.

### BRIEF SUMMARY

Certain aspects provide a processor-implemented method for generating a channel estimate using machine learning models. The method generally includes generating a set of layer-specific adaptation parameters using a first machine learning model trained to generate the set of layer-specific adaptation parameters based on a sensing matrix and a learned sparsifying dictionary; generating a set of layer-specific sparse vector representations and the learned sparsifying dictionary using a second machine learning model trained to generate the set of layer-specific sparse vector representations based on the sensing matrix and the generated set of layer-specific adaptation parameters; generating a channel estimate based on at least one layer-specific sparse vector representation from the set of layer-specific sparse vector representations; and taking one or more actions based on the generated channel estimate.

Certain aspects provide a processor-implemented method for training a neurally augmented machine learning model. The method generally includes training a first machine learning model to generate a set of layer-specific adaptation parameters based on a sensing matrix and a learned sparsifying dictionary; and training a second machine learning model to generate a set of layer-specific sparse vector representations and the learned sparsifying dictionary based on a training data set mapping the sensing matrix and the generated set of layer-specific adaptation parameters to a channel state of a communication channel.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 depicts an example environment for channel estimation using machine learning.

FIG. 2 depicts an example workflow to train machine learning models to perform improved channel estimation.

FIG. 3 depicts an example workflow to perform channel estimation using trained machine learning models.

FIG. 4 is a flow diagram depicting an example method for training machine learning models for channel estimation.

FIG. 5 is a flow diagram depicting an example method for performing channel estimation using machine learning models.

FIG. 6 is a flow diagram depicting an example method for generating sparse vectors using machine learning for improved channel estimation.

FIG. 7 is a flow diagram depicting an example method for determining channel estimations using machine learning.

FIG. 8 depicts an example workflow to perform channel estimation using an augmented machine learning model.

FIG. 9 depicts an example architecture for a first machine learning model of the augmented machine learning model.

FIGS. 10 and 11 are flow diagram depicting example methods for training an augmented machine learning model.

FIGS. 12 and 13 are flow diagrams depicting example methods for performing channel estimation using an augmented machine learning model.

FIG. 14 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for machine-learning-based channel estimation.

Channel estimation can be a significant problem in a variety of wireless communication systems, and particularly in multiple-input, multiple-output (MIMO) wireless systems. Although some examples described in the present disclosure involve using machine learning for channel estimation in millimeter wave systems (e.g., systems in which communications are performed using frequency bands above 24 GHz, where the wavelength is on the order of millimeters), beamforming systems, and/or MIMO systems, aspects of the present disclosure are readily applicable to any estimation problem with underdetermined measurements or parameters.

A variety of compressed sensing techniques have been used in the context of mmWave and massive MIMO channel estimation, but the channel estimation problem remains an underdetermined problem. For example, in systems using analog beamforming, the channel observations are generally a lower dimensionality representation of a relatively higher-dimension channel. To generate channel estimates, some compressed sensing techniques can attempt to leverage sparsity of the channel in the spatial domain (rather than an antenna-focused domain). That is, the channel may be relatively dense in the spatial domain (e.g., with most elements having similar values and with little or no structure). In the angular domain, however, the channel is generally sparse (with most elements having a low or null value) and structured (with few elements having significant values). For example, the outer product of antenna responses on the transmit side and the receive side may be used as atoms or elements of a sparsifying dictionary that can be used to provide compressed sensing and channel estimations. In some aspects, the channel can be represented as the product between the sparsifying dictionary Ψ and a sparse vector representation of the signal, where the sparsifying dictionary corresponds to the angular domain of the transmitter and receiver.

Some approaches for solving this compressed sensing problem involve a number of complications or tradeoffs, such as iterative methods like orthogonal matching pursuit (OMP) techniques, iterative hard-thresholding algorithm (IHTA) techniques, iterative soft-thresholding algorithm (ISTA) techniques, and approximate message-passing (AMP) techniques. The hyperparameters of such algorithms (e.g., the number of iterations and the thresholds) can be manually tuned to attempt to optimize the performance/complexity trade-off, but some approaches remain significantly limited in their flexibility and accuracy.

Some machine learnings methods have been used to attempt to learn sparse recovery algorithms from sample data. For example, techniques like learned ISTA (LISTA) have attempted to solve the channel estimation problem by using fixed (or static) sensing matrices (also referred to as measurement matrices) and sparsifying dictionaries. However, because realistic deployments are generally dynamic, the use of static (or fixed) sensing matrices and sparsifying dictionaries generally results in inherently limited estimations, preventing accurate and reliable channel estimations in a wide variety of realistic deployments.

In aspects of the present disclosure, techniques are provided to consider the channel in its full generality (e.g., with planar dual polarization antenna arrays in three-dimensional space). However, the dimensionality of such problems expands rapidly in these deployments, which makes the sparse recovery problem significantly more complex. To allow for the consideration of a channel in its full generality while minimizing, or at least reducing, the computational complexity of estimating a channel, certain aspects of the present disclosure use a dictionary LISTA (DLISTA) approach. In some aspects, the DLISTA architecture can be implemented as an unrolled version of ISTA in which the ISTA algorithm is implemented as a neural network in which each iteration of the ISTA algorithm is mapped into a layer of the neural network to perform the processing operations. The DLISTA architecture disclosed herein can jointly learn both the sparsifying dictionary and the reconstruction algorithm(s), and can considerably reduce the number of iterations involved (e.g., the number of layers of the neural network model), as well as reduce the dictionary dimensionality. For example, in given environments there are generally correlations between different channel clusters, such that the sparse angular domain representation has additional structure that can be captured by the dictionary learning techniques described herein. Additionally, the joint learning of the dictionary and other parameters contributes to faster convergence, enabling a reduced number of layers and/or iterations. By doing so, the computational complexity of the model may be reduced, thereby reducing both training time and inference time and reducing power consumption for both training and inferencing. Additionally, such improvements make it practical to use the trained model on low power devices (e.g., mobile devices) to perform channel estimation.

Additionally, in contrast to techniques relying on a fixed sensing matrix and/or a pre-computed sparsifying dictionary, aspects of the present disclosure can enable use of variable or dynamic sensing matrices and learned dictionaries, which can significantly improve the accuracy and performance of the models and better represent realistic systems.

### Example Environment for Channel Estimation Using Machine Learning

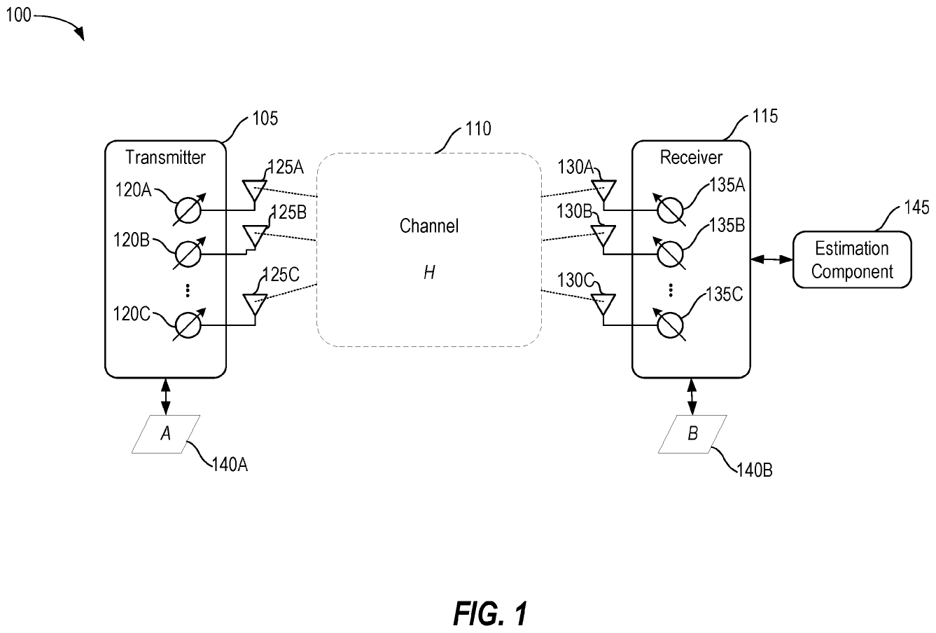

FIG. 1 depicts an example environment 100 for channel estimation using machine learning. In the illustrated example, the environment is a MIMO system using analog beamforming for wireless communications. In at least one aspect, the environment 100 corresponds to a mmWave MIMO system.

As illustrated, the environment 100 includes a transmitter 105 and a receiver 115 communicating via a channel 110. In the depicted example, the transmitter 105 uses a set of transmitting antennas 125A-125C, while the receiver 115 uses a set of receiving antennas 130A-130C. Although three antennas are depicted on each device, the transmitter 105 and the receiver 115 can generally use any number of antennas. Additionally, although the illustrated example depicts a single transmitter 105 and a single receiver 115, in some aspects, each device may operate as both a transmitter and receiver (e.g., a transceiver). Further, though not included in the illustrated example, in some aspects, some or all of the antennas of the transmitter 105 and/or the receiver 115 may be arranged into one or more discrete subarrays. In some aspects, the transmitter 105 corresponds to a wireless base station, such as a Fifth Generation (5G) radio base station (e.g., a gNodeB), while the receiver 115 corresponds to user equipment.

In some aspects, the transmitter 105 can wirelessly communicate with (e.g., transmit signals to) the receiver 115 via one or more communications links (e.g., via the channel 110). The communications links between BSs and UEs may support uplink (UL) (also referred to as reverse link) transmissions from a UE to a BS and/or downlink (DL) (also referred to as forward link) transmissions from a BS to a UE. The communications links may use multiple-input, multiple-output (MIMO) antenna technology, including spatial multiplexing, beamforming, and/or transmit diversity in various aspects.

BSs (such as a device with the transmitter 105) may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and others. Each BS may provide communications coverage for a respective geographic coverage area, which may sometimes be referred to as a cell, and which may overlap other coverage areas in some cases (e.g., a small cell may have a coverage area that overlaps the coverage area of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home), and/or other types of cells.

In some aspects, the receiver 115 is part of a UE. UEs may generally include: a cellular phone, smartphone, session initiation protocol (SIP) phone, laptop, personal digital assistant (PDA), satellite radio, global positioning system (GPS) device, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always-on (AON) devices, edge processing devices, or other similar devices. UEs may also be referred to more generally as a mobile device, a wireless device, a wireless communications device, a station (STA), a mobile station (MS), a subscriber station, a mobile subscriber station, a mobile unit, a subscriber unit, a wireless unit, a remote unit, a remote device, an access terminal, a user terminal (UT), a mobile terminal, a wireless terminal, a remote terminal, a handset, a handheld device, and other terms.

In the depicted environment 100, the transmitter 105 and the receiver 115 use a set of phase shifters 120A-120C (collectively referred to herein as “phase shifters 120”) and a set of phase shifters 135A-135C (collectively referred to herein as “phase shifters 135”) to provide analog beamforming according to beamforming codebooks 140A and 140B, respectively. Specifically, each transmitting antenna 125 of the transmitter 105 may have a corresponding phase shifter 120, and each receiving antenna 130 of the receiver 115 may have a corresponding phase shifter 135. As discussed above, the use of multiple antennas on each side of the transmission (e.g., the fact that the environment is a MIMO system) and the use of analog beamforming (using the phase shifters 120 and 135) significantly increases the complexity of performing channel estimation.

The channel 110 generally represents the wireless medium through which the signal propagates from the transmitter 105 to the receiver 115. The properties of the channel 110 can significantly affect how the signal propagates. As such, channel estimation using machine learning may be used to determine, predict, or infer the state of the channel 110. In some aspects, the signal observed by the receiver 115 may be formulated as Y=AHB, where Y is the observed signal (also referred to as a channel observation), A and B are the analog beamforming codebooks 140A and 140B (also referred to as beamforming matrices, which may be proprietary and/or changing over time) used by the transmitter 105 and the receiver 115, respectively, and H represents the channel 110. Generally, the goal of channel estimation is to estimate or predict the channel H based on the channel observation Y.

In the illustrated example, an estimation component 145 is communicably coupled with the receiver 115. Although depicted as a discrete component for conceptual clarity, in some aspects, the estimation component 145 is integrated into the receiver 115. In some aspects, the estimation component may use machine learning to provide channel estimations for the channel 110, as discussed in more detail below. Additionally, though depicted as coupled with the receiver 115, in some aspects, the estimation component 145 may be integrated with or coupled to other components, such as the transmitter 105.

In some systems, the channel estimate is determined based on various data points, including element response matrices of the receiver 115 and the transmitter 105 computed at two-dimensional angular grid points, and the response matrices can be used to define the sparsifying dictionary that is used to reconstruct the channel. That is, some approaches generally entail the use of a priori known response matrices (e.g., the antenna element response at any given direction) to define a fixed and static sparsifying dictionary which can be used to reconstruct a channel. In contrast, aspects of the present disclosure enable the sparsifying dictionary to be learned during training, as discussed in further detail below. Additionally, as discussed above, some systems generally use a fixed measurement or sensing matrix, while aspects of the present disclosure enable varying sensing matrices.

In some aspects, the use of a varying sensing matrix may be useful in the context of MIMO systems and beamforming systems. As aspects of the present disclosure do not use a priori knowledge about the sparsifying set of basis vectors for the signal to be recovered, nor do these aspects use a fixed sparsifying dictionary, the techniques described herein can significantly improve the performance and accuracy of models used in channel estimation tasks. In some aspects, the channel 110 is estimated by learning a sparsifying dictionary beginning from a randomized basis, rather than from a computed dictionary. In some aspects, the system can additionally or alternatively receive a pre-computed sparsifying dictionary, and refine or fine-tune this dictionary during the training process.

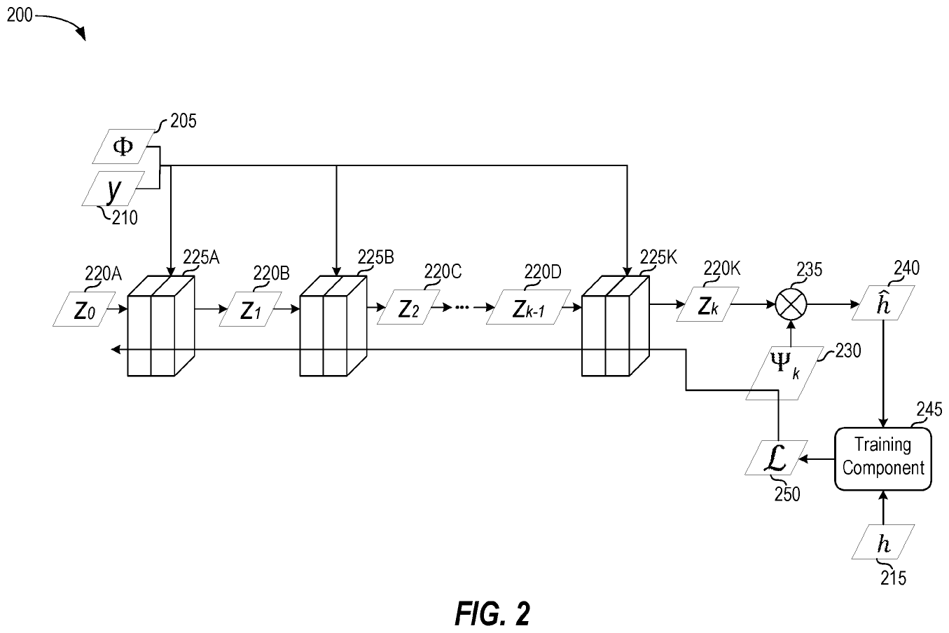

Once the model(s) are trained (as discussed below with reference to FIG. 2), the trained models can be used to generate channel estimates that can drive a variety of further operations to improve the functionality of the network or environment. For example, by estimating the channel 110, a system can enable improved analog beamforming design, faster beam selection, improved spectral efficiency prediction, sensing or positioning (e.g., locating objects in the space), link adaptation, communication parameter selection, and the like. For example, the estimated channel can be used to design the beamforming codebooks used by the transmitter and/or receiver to achieve better end-to-end performance.

### Example Workflow for Training Machine Learning Models for Channel Estimation

FIG. 2 depicts an example workflow 200 to train machine learning models to perform improved channel estimation. In some aspects, the workflow 200 is used to provide offline training of machine learning models. The training can generally be performed by any suitable device or system, such as dedicated training systems.

The workflow 200 generally uses a supervised training approach to refine the parameters of the model based on training exemplars, where each exemplar includes a channel observation (y) 210, a corresponding sensing matrix (Φ) 205, and a ground-truth or known channel state (h) 215. Generally, the channel observation 210 corresponds to the signal observed at a receiver (e.g., the receiver 115 of FIG. 1). The sensing matrix 205 is a function of the beamforming matrices (which are often proprietary designs, and are generally known to the receiver and transmitter devices) used for the measurement or signal observation. In some aspects, the sensing matrix 205 is the Kronecker product of the two beamforming codebooks. For example, the sensing matrix 205 may be defined as B^{T}⊗A, where B^{T} is the transpose of matrix B (which may correspond to the beamforming codebook of the receiver used to observe the observation 210, as discussed above) and A is the beamforming codebook of the transmitter used to generate the transmission.

Further, the sensing matrix can additionally be parameterized and learnable (alongside the sparsifying dictionary). By learning the sensing matrix, the model may thereby learn new, accurate beamforming matrices for the receiver and transmitter, which may improve the quality of communications between a transmitter and a receiver.

As discussed above, the workflow 200 enables the sensing matrix 205 to differ or vary for each observation. That is, each observation 210 may have a corresponding sensing matrix 205, rather than using a fixed sensing matrix for all samples. Because each observation may have a corresponding sensing matrix, the resulting model may have improved inference accuracy (e.g., channel estimates that are closer to the actual state of the channel) than models in which a fixed sensing matrix is used.

In the illustrated aspect, the machine learning architecture includes a set of one or more layers 225A, 225B, and 225K (collectively referred to herein as “layers 225”). Although three layers are depicted in the machine learning model of FIG. 2, in other aspects, the number of layers (also referred to as the number of iterations of the model) may differ. Each layer 225 may correspond to a layer of a neural network model. For example, in some aspects, a single layer 225 is used. The training workflow 200 generally includes learning a parameterized function map f_{θ} that, given an observation and a sensing matrix (e.g., yᵢ, Φᵢ for the i^{th} data sample), predicts the sparse representation for the channel. This sparse representation is indicated by blocks labeled “220A”-“220K” and is refined or updated as the data passes through each layer 225 of the model.

At the output of the model, the final sparse representation 220K is combined with a learned sparsifying dictionary 230 (e.g., by multiplication operation 235) to generate a channel estimate 240 (denoted as h). This channel estimate 240 can then be compared against the known channel state 215 (denoted as h) by a training component 245 to generate a loss 250, which is then used to refine the model parameters via a loss function designed to minimize, or at least reduce, the difference between channel estimates generated by the model and known channel states associated with a given channel observation y and sensing matrix.

In some aspects, the model uses a set of learnable parameters Θ={γ, θ, Ψ}, where γ is a learned step size used by the model, θ is a learned threshold used by the model, and Ψ is a sparsifying dictionary used by the model, each of which is discussed in more detail below. In at least one aspect, each layer 225 of the model uses a shared value for the trainable parameters, such that the step size γ, threshold θ, and sparsifying dictionary Ψ may be learned and used across all layers. In some aspects, each layer 225 uses a separate value for each trainable parameter such that the system may learn a respective step size, a respective threshold, and a respective sparsifying dictionary for each layer 225 of the model.

In the illustrated workflow 200, each layer 225A-K receives a sparse vector representation of the wireless signal (indicated by blocks labeled “220A”-“220K”) and outputs an updated value or version of the sparse representation. Specifically, the layer 225A receives sparse representation 220A and outputs sparse representation 220B, the layer 225B receives the sparse representation 220B and outputs sparse representation 220C, and so on. As illustrated, each layer 225 computes the updated sparse representation 220 further using the channel observation 210 and the sensing matrix 205.

In some aspects, the sparse representation 220 output by a given layer 225 with index k based on an input exemplar i (having observation yᵢ and sensing matrix Φᵢ) is defined using Equation (1) below, where

$${z}_{i}^{k + 1}$$

is the sparse representation output by the layer k based on input sample i,

$${z}_{i}^{k}$$

is the sparse representant that is input to the layer k based on sample i, n_{θ}_{^{k}} is a soft thresholding function for layer k where θ is a learned threshold (which may be unique to the layer k, or may be shared across layers) and g is an update value computed using Equation (2) below. In some aspects, the soft threshold operation sets values within the range defined by θ to zero (e.g., values between −|θ| and |θ|), while values outside of this range are passed through unchanged or scaled. In some aspects, the sparse representation output by the layer k,

$${z}_{i}^{k + 1} ,$$

may be represented as:

$${z}_{i}^{k + 1} = {η}_{{θ}^{k}} ( {z}_{i}^{k} + g ) \qquad ( 1 )$$

For example, for the layer 225B, the output sparse representation 220C is generated by summing the input sparse representation 220B and an update value, and applying a thresholding operation using threshold θ. In some aspects, the update value g may be defined using Equation (2) below, where γ^{k} is the learned step size of the layer k (which may be unique to the layer k, or may be a shared value across layers), Φᵢ is the sensing matrix of the input sample i (e.g., the sensing matrix 205 that corresponds to the observation 210), Ψ^{k} is the learned sparsifying dictionary used by the layer k (which may be unique to the layer k, or may be shared across layers), and r is a residual value computed using Equation (3) below.

g=γ^{k}(ΦᵢΨ^{k})^{T}·r (2)

In some aspects, the residual value r is defined using Equation (3) below, where yᵢ is the channel observation 210 for sample i, Φᵢ is the sensing matrix of the input sample i (e.g., the sensing matrix 205 that corresponds to the observation 210), Ψ^{k} is the learned sparsifying dictionary used by the layer k (which may be unique to the layer k, or may be shared across layers), and

$${z}_{i}^{k}$$

is the sparse representation input to the layer k based on sample i.

$$r = {y}_{i} - {Φ}_{i} {Ψ}^{k} {z}_{i}^{k} \qquad ( 3 )$$

For example, for the layer 225B, the residual value is generated by multiplying the sensing matrix 205 with the learned sparsifying dictionary of the layer 225B and the input sparse representation 220B and subtracting this value from the channel observation 210.

In some aspects, the first sparse representation 220A (used as input to the first layer 225A of the model) can be instantiated in a variety of ways, such as using a predefined value. For example, in some aspects, the first sparse representation 220A is generated by initializing a vector with a value of zero (e.g., where all elements of the vector are zero). In some aspects, the initial sparse representation 220A can be initiated using random or pseudo-random values.

In the illustrated workflow 200, the input sensing matrix 205 and the channel observation 210 are provided to each layer 225A-K of the model, which use these values and the input sparse representations 220A-D to compute updated or output sparse representations 220B-K using Equations (1), (2), and (3) above. At the output of the final layer 225K (which may, in some cases, be the first and only layer of the model), the sparse representation 220K is multiplied with the learned sparsifying dictionary 230 to generate the channel estimation 240. In some aspects, if a single sparsifying dictionary is shared across the layers 225, this shared dictionary may be used as the sparsifying dictionary 230. In some aspects, if each layer learns its own respective dictionary, the sparsifying dictionary 230 can similarly be learned as a discrete dictionary during training.

As illustrated, the channel estimate 240 (generated based on the channel observation 210 and the sensing matrix 205) is then evaluated by the training component 245, alongside the ground-truth channel state 215, to generate the loss 250. For example, in at least one aspect, the training component 245 computes the mean-squared error and/or normalized mean squared error between the channel estimation 240 and the channel observation 210. As illustrated, this loss 250 can then be backpropagated through the model (including the sparsifying dictionary 230, if a separate dictionary is used, and each layer 225A-K) to refine the parameters of the model (e.g., to refine the step size, sparsifying dictionary, and threshold values used by each layer). In some aspects, rather than training the step size parameter(s), these values can remain fixed. This can improve training stability for some datasets, easing convergence of the model.

In aspects, the trained parameters of the model can be initialized (e.g., at the beginning of training) in a variety of ways. For example, in at least one aspect, the parameters (e.g., step size(s), sparsifying dictionary or dictionaries, and/or threshold(s)) can be initialized randomly or pseudo-randomly. In at least one aspect, the sparsifying dictionary (or dictionaries) can alternatively be instantiated using one or more other techniques, such as by applying sparse principal component analysis (SPCA) to some or all of the training dataset. The values of the dictionary (and other parameters) can then be refined or fine-tuned during training.

In some aspects, as discussed above, the system can learn the sparsifying dictionary Ψ in its entirety. In some aspects, the system may determine a component or subset of the sparsifying dictionary from other sources, and learn the remaining portions. For example, in such aspects, the system can receive the sparsifying dictionary used by the transmitting device for the communication. As the overall sparsifying dictionary Ψ may be the Kronecker product of the receiver dictionary and transmitter dictionary, in some aspects, the system can use the (known) transmitter dictionary to optimize learning of the overall sparsifying dictionary Ψ (e.g., to learn only the receiver side).

In the illustrated example, the training system processes the entire channel observation 210 and the sensing matrix 205 to refine the model. For example, the channel observation 210 may be a vector having 128 elements, while the sensing matrix 205 is a matrix with 128 rows and 128 columns. However, in some aspects, acquiring and/or processing such voluminous data may be unrealistic (e.g., because capturing this data would consume significant power, which is often limited on certain types of receiving devices, such as mobile and other low-power user equipment). In some aspects, therefore, although 128 measurements may be available in the observation 210, the training system can use a subset of these values when training the model. In such aspects, the training system may use N values (e.g., N=5 values) having the highest reference signal received power (RSRP), received signal quality indicator (RSQI), and/or received signal strength indicator (RSSI) in the channel observation 210. For example, the training system may use values in only the first five elements (e.g., rows) in the observation 210 (and the values of corresponding elements (e.g., rows) in the sensing matrix) to train the model. As a result, the (subset of the) sensing matrix may be an underdetermined system having more columns (e.g., 128 columns) than rows (e.g., 5 rows), enabling the channel estimation problem to be effectively cast as a sparse recovery problem that is efficiently solved using the models described herein.

Once a given input sample (including the sensing matrix 205, the observation 210, and the channel state 215) has been used to refine the model, subsequent samples may similarly be used to generate corresponding channel estimates 240 and losses 250. In some aspects, this training workflow 200 can be performed using stochastic gradient descent (e.g., backpropagating each loss 250 for each input sample individually) and/or batch gradient descent (e.g., refining the model based on loss 250 generated for a batch of input samples).

Once training is complete, the model architecture can be used to generate channel estimations during runtime inferencing based on input observations and sensing matrices, as discussed in more detail below.

### Example Workflow for Channel Estimation Using Machine Learning Models

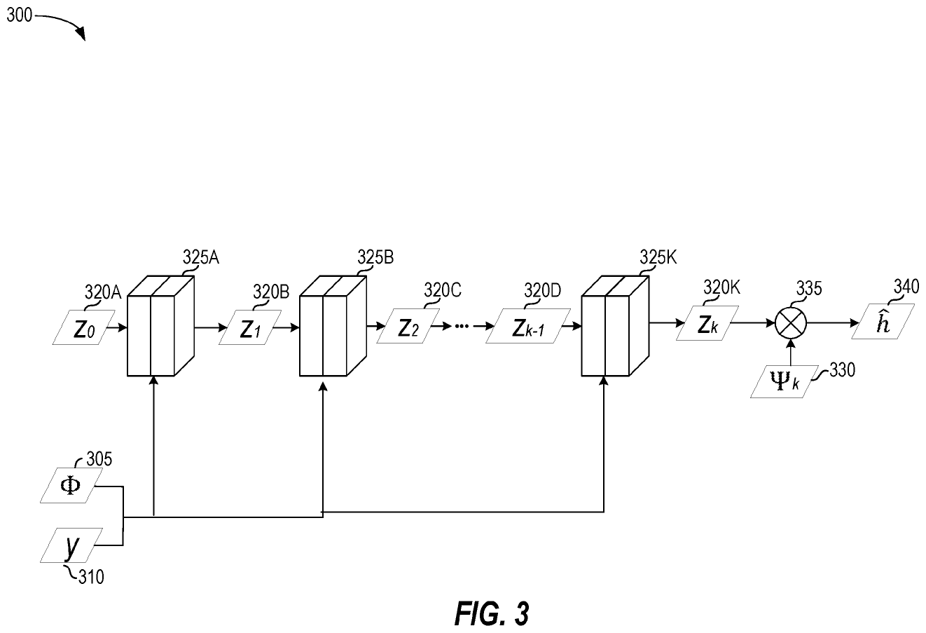

FIG. 3 depicts an example workflow 300 to perform channel estimation using trained machine learning models. In some aspects, the workflow 300 is used to provide online inferencing using machine learning models by an inferencing system. In at least one aspect, the workflow 300 is performed by a base station or user equipment participating in the wireless communication (e.g., by the receiver 115 of FIG. 1 and/or by a device or system that includes or uses the receiver).

The workflow 300 generally uses a trained machine learning model (e.g., trained using the workflow 200 of FIG. 2) to generate a channel estimate 340 based on input data (including a channel observation 310 and a corresponding sensing matrix 305). As discussed above, the channel observation 310 generally corresponds to the signal perceived by a receiver (e.g., the receiver 115 of FIG. 1), and the sensing matrix 305 is generally defined based on the beamforming codebooks used by the transmitter and receiver when the signal was observed.

As discussed above with reference to FIG. 2, the trained model of FIG. 3 can process the observation 310 and the sensing matrix 305 to generate a sparse representation 320K of the wireless signal, and use this representation in conjunction with a learned sparsifying dictionary 330 to generate the channel estimate 340 (e.g., via a multiplication operation 335).

As discussed above, in contrast to some approaches, the workflow 300 enables the sensing matrix 305 to differ or vary. That is, each observation 310 may have a corresponding sensing matrix 305, rather than using a fixed sensing matrix for all samples. In the illustrated aspect, the machine learning architecture includes a set of one or more layers 325A, 325B, and 325K (collectively referred to herein as “layers 325”) for processing the data. As discussed above, each layer 325 may be a layer of a neural network. Although three layers are depicted in FIG. 3, in other aspects, the number of layers (also referred to as the number of iterations of the model) may differ. For example, in some aspects, a single layer 325 is used, and in other aspects, additional layers are used.

As illustrated, the system can first generate, initialize, or instantiate an initial sparse representation 320A (e.g., randomly or using a defined fixed value such as zero), and provide this sparse representation 320A as input, alongside the observation 310 and the sensing matrix 305, to the first layer 325A of the network. The layer 325A may process these data as discussed above based at least in part on a set of learned parameters (e.g., a learned step size, a learned sparsifying dictionary, and/or a learned threshold value). In some aspects, each layer 325 has a corresponding set of learned parameters. That is, the learned parameters may be specific to each layer 325. In other aspects, some or all of the learned parameters may be shared across multiple or all of the layers 325.

As a result of the processing, the layer 325A outputs an updated sparse representation 320B (e.g., using Equations (1), (2), and (3)). For example, as discussed above, the layer 325A may determine a residual value based on the observation 310, the sensing matrix 305, a learned sparsifying dictionary, and the sparse vector representation (e.g., using Equation (3) above). Similarly, the layer 325A may use the residual value, the sensing matrix 305, the learned sparsifying dictionary, and the step size (which may be learned or may be fixed, as discussed above) to generate an update value (e.g., using Equation (2) above). The layer 325A can then generate the updated sparse representation 320B based on the update value and the input sparse representation 320A, which may include using a thresholding operation with a learned threshold (e.g., using Equation (1) above).

As illustrated, this process of updating the sparse representation 320 can be iteratively performed by one or more of the layers 325 until the final output sparse representation 320K is generated. As illustrated, by multiplying this sparse representation 320K with the learned sparsifying dictionary 330, the channel estimate 340 is generated. As discussed above, the learned sparsifying dictionary 330 may be shared across the layers 325 of the model (e.g., where each layer 325 uses the same shared sparsifying dictionary 330), or may be a separate dictionary learned alongside the rest of the model during training.

As discussed above, the channel estimate 340 can then be used for a variety of purposes, such as improving analog beamforming, beam selection, spectral efficiency prediction, and the like.

### Example Method for Training Machine Learning Models for Channel Estimation

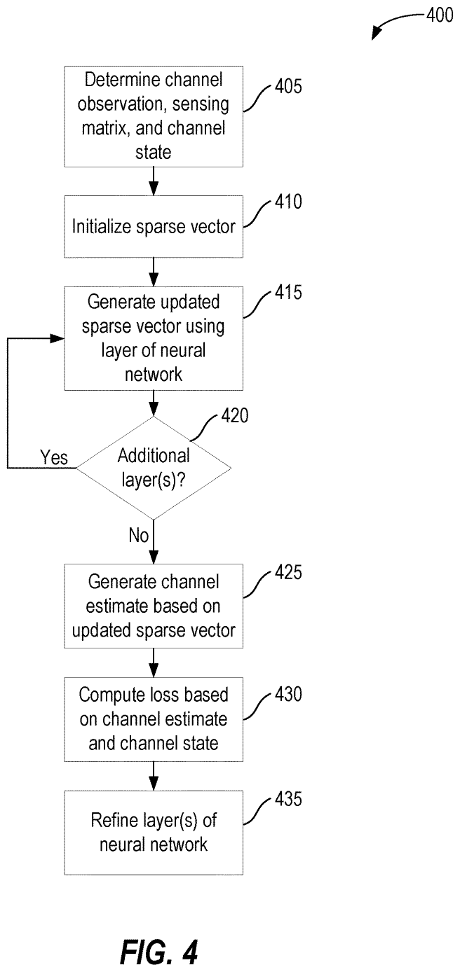

FIG. 4 is a flow diagram depicting an example method 400 for training machine learning models for channel estimation. In some aspects, the method 400 provides additional detail for the workflow 200 of FIG. 2. In some aspects, the method 400 is performed to provide offline training of one or more machine learning models, such as by a training device or system.

At block 405, the training system determines, identifies, receives, or otherwise accesses a training sample including a channel observation (e.g., the observation 210 of FIG. 2), a sensing matrix (e.g., the sensing matrix 205 of FIG. 2), and a channel state (e.g., the channel state 215 of FIG. 2). In some aspects, as discussed above, the channel observation corresponds to a wireless signal as observed or measured by a receiver, the sensing matrix is defined based on the parameters used to transmit and/or receive the signal (e.g., the beamforming codebooks used by the transmitter and receiver), and the channel state corresponds to the properties of the wireless medium when the signal was transmitted.

In some aspects, the channel observation, sensing matrix, and channel state may generally be determined or received as part of a training sample or exemplar, as discussed above. By using such samples, the training system can iteratively refine the machine learning model to generate improved sparse representations of the wireless signal when provided new channel observations and sensing matrices. As discussed above, these sparse representations can in turn be used (alongside a learned sparsifying dictionary) to generate accurate channel estimations.

At block 410, the training system initializes a sparse vector representation of the signal. For example, as discussed above, the training system can initialize this first representation with a value of zero (e.g., where all elements of the vector are zero). This may correspond, for example, to the sparse representation 220A of FIG. 2.

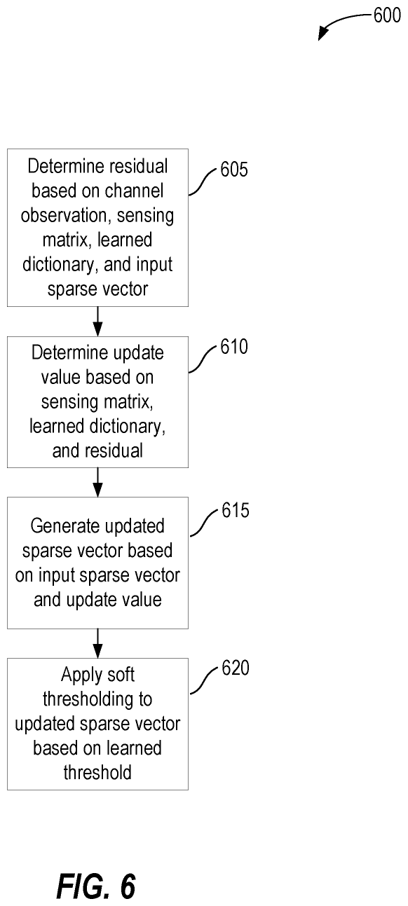

At block 415, the training system generates an updated sparse representation (e.g., sparse representation 220B of FIG. 2, which may be a vector) using a layer (e.g., the first layer 225A of FIG. 2) of a neural network model. For example, as discussed above, the training system can process the initial or current sparse vector (initialized in block 410), the channel observation, and the sensing matrix in order to generate an updated sparse vector representation. In some aspects, this includes processing the data using trained parameters (e.g., a trained step size, a trained sparsifying dictionary, and/or a trained threshold), which may be unique to the current layer of the network, or may be shared across layers. In at least one aspect, the training system can use Equations (1), (2), and (3), discussed in detail above, to generate the updated sparse vector. One example technique for performing block 415 is described in more detail below with reference to FIG. 6.

At block 420, the training system determines whether there is at least one additional layer remaining in the model. That is, the training system can determine whether the layer processed at block 415 was the last or final layer. If there is at least one additional layer remaining, the method 400 returns to block 415, where the training system can generate a new updated sparse vector by processing the current vector (which was generated at block 415 using the prior/initial sparse vector) using the next layer of the model. In this way, the method 400 can proceed to process data through each layer of the model, iteratively refining or updating the sparse vector representation as each layer is passed.

If no further layers remain, the method 400 continues to block 425. At block 425, the training system generates a channel estimate (e.g., the channel estimate 240 of FIG. 2) based on the most recent or current updated sparse channel representation that was generated by the final layer of the model (e.g., the sparse representation 220K of FIG. 2). For example, as discussed above, the training system may multiply the updated sparse vector with a trained sparsifying dictionary (e.g., the sparsifying dictionary 230 of FIG. 2) in order to generate the channel estimate.

At block 430, the training system can then compute a loss based on the channel estimate (generated at block 425) and the known channel state (determined at block 405). For example, as discussed above, the training system may compute the normalized mean squared error between the channel estimate and channel state. Although the illustrated example depicts generating the loss based on a single training sample (e.g., a single observation with a corresponding sensing matrix and channel state), in some aspects, the training system can use batch training to generate a loss based on multiple samples.

At block 435, the training system can then refine the layer(s) of the neural network model based on the loss, as discussed above. For example, the training system may use backpropagation to refine the parameters of each layer, beginning with the final layer (or beginning with the final sparsifying dictionary used to generate the channel estimate) and moving towards the first. Generally, the method 400 can be used to refine the neural network model using any number and variety of training samples.

In some aspects, as discussed above, the training system can train or refine a separate set of parameters for each layer of the model. That is, each respective layer may have a respective learned step size, learned sparsifying dictionary, and/or learned threshold value. In such aspects, the training system can also use the loss to refine a final sparsifying dictionary used to generate the channel estimate. In some aspects, the training system may use a set of shared parameters across the layers, as discussed above.

By using the method 400, the training system can train the model to generate significantly improved channel estimates, particularly for MIMO systems and/or systems using analog beamforming. Additionally, as discussed above, the trained model can generally use sparsifying dictionaries having lower dimensionality, as compared to some approaches, enabling the models to be used by devices or systems with more limited computational or power resources, such as user equipment.

### Example Method for Channel Estimation Using Machine Learning Models

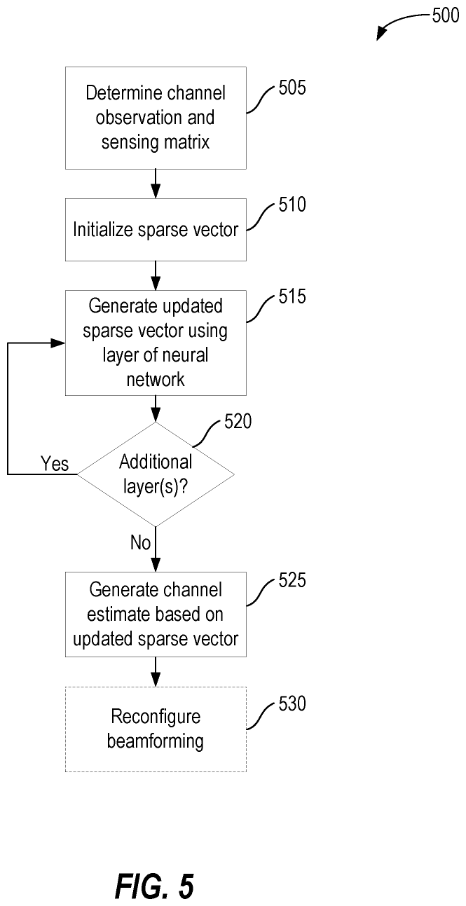

FIG. 5 is a flow diagram depicting an example method 500 for performing channel estimation using machine learning models. In some aspects, the method 500 provides additional detail for the workflow 300 of FIG. 3. In some aspects, the method 500 is performed by an inferencing device or system. In at least one aspect, the method 500 is performed by user equipment participating in wireless communications. In some aspects, the method 500 can additionally or alternative be performed by a base station participating in the communications.

At block 505, the inferencing system determines, identifies, receives, or otherwise accesses a data sample including a channel observation (e.g., the observation 310 of FIG. 3) and a sensing matrix (e.g., the sensing matrix 305 of FIG. 3). In some aspects, as discussed above, the channel observation corresponds to a wireless signal as observed or measured by a receiving device or system, and the sensing matrix is defined based on the parameters used to transmit and/or receive the signal (e.g., the beamforming codebooks used by the transmitter and receiver).

In some aspects, the channel observation and sensing matrix may generally be determined or received as part of a data sample for runtime processing, as discussed above. By evaluating such samples, the inferencing system can generate an accurate sparse representation of the wireless signal. As discussed above, this sparse representation can in turn be used (alongside a learned sparsifying dictionary included in the model) to generate accurate channel estimates.

At block 510, the inferencing system initializes a sparse vector representation of the signal. For example, as discussed above, the inferencing system can initialize this first representation with a value of zero (e.g., where all elements of the vector are zero). This may correspond, for example, to the sparse representation 320A of FIG. 3.

At block 515, the inferencing system generates an updated sparse vector (e.g., the sparse representation 320B of FIG. 3) using a layer (e.g., the first layer) of a neural network model. For example, as discussed above, the inferencing system can process the initial or current sparse vector (initialized in block 510), the channel observation, and the sensing matrix in order to generate an updated sparse vector representation. In some aspects, this includes processing the data using trained parameters (e.g., a trained step size, a trained sparsifying dictionary, and/or a trained threshold), which may be unique to the current layer of the network, or may be shared across layers. In at least one aspect, the inferencing system can use Equations (1), (2), and (3), discussed in detail above, to generate the updated sparse vector. One example technique for performing block 515 is described in more detail below with reference to FIG. 6.

At block 520, the inferencing system determines whether there is at least one additional layer remaining in the model. That is, the inferencing system can determine whether the layer processed at block 515 was the last or final layer. If there is at least one additional layer remaining, the method 500 returns to block 515, where the inferencing system can generate a new updated sparse vector by processing the current vector (which was generated at block 515 using the prior/initial sparse vector) using the next layer of the model. In this way, the method 500 can proceed to process data through each layer of the model, iteratively refining or updating the sparse vector representation as each layer is passed.

If no further layers remain, the method 500 continues to block 525. At block 525, the inferencing system generates a channel estimate (e.g., the channel estimate 340 of FIG. 3) based on the most recent or current updated sparse channel representation that was generated by the final layer of the model (e.g., the sparse representation 320K of FIG. 3). For example, as discussed above, the inferencing system may multiply the updated sparse vector with a learned sparsifying dictionary (e.g., the sparsifying dictionary 330 of FIG. 3) in order to generate the channel estimate.

At block 530, the inferencing can then use the channel estimate to reconfigure, refine, or otherwise improve the wireless communications, such as by redefining the beamforming configuration. For example, as discussed above, the channel estimate can be used to inform or drive analog beamforming design, to enable faster and more accurate beam selection for the communication, and/or to provide improved spectral efficiency predictions.

### Example Method for Sparse Vector Generation Using Machine Learning for Channel Estimation

FIG. 6 is a flow diagram depicting an example method 600 for generating sparse vectors using machine learning for improved channel estimation. In some aspects, the method 600 provides additional detail for block 415 of FIG. 4 and/or block 515 of FIG. 5 (where the updated sparse vector representation is generated). Accordingly, the method 600 may be performed by a computing system that corresponds to an offline training system or an online inferencing system.

At block 605, the computing system determines or generates a residual value based on a channel observation y, a corresponding sensing matrix, a learned sparsifying dictionary Ψ, and an input sparse vector z. For example, the computing system may use Equation (3), discussed in more detail above, to generate the residual. In some aspects, this residual can then be projected back onto the sparse vector space to evaluate the sparse vector (e.g., to determine an update value).

At block 610, the computing system determines or generates an update value based on the sensing matrix, the learned sparsifying dictionary, and the residual value. In some aspects, the computing system can also determine the update value based on a step size, which may be a predefined and fixed value or a learned value. For example, the computing system may use Equation (2), discussed above, to generate the update value.

At block 615, the computing system generates an updated sparse vector representation based on the input sparse vector representation (which was provided to the layer as input) and the update value. For example, the computing system may use Equation (1), discussed above in more detail, to generate the updated sparse vector.

At block 620, the computing system can then apply a soft thresholding to the updated sparse vector, based on a learned threshold value. For example, as discussed above with reference to Equation (1), the computing system may use a learned threshold value to set some values (e.g., those within a learned threshold distance from zero) to a value of zero.

This updated sparse vector representation can then be provided for downstream processing, such as via input to a subsequent layer of the model. Similarly, if the current layer is the final model layer, the updated sparse vector representation can be used to generate the channel estimate (e.g., by multiplying the representation with a learned sparsifying dictionary).

### Example Method for Determining Channel Estimates Using Machine Learning

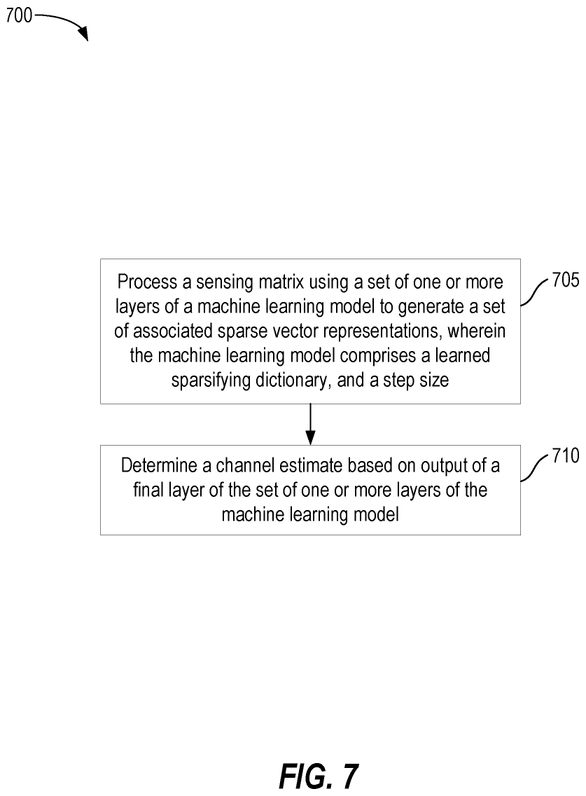

FIG. 7 is a flow diagram depicting an example method 700 for determining channel estimates using machine learning. In some aspects, the method 700 is performed by the user equipment participating in wireless communications. In some aspects, the method 700 can additionally or alternative be performed by the base station participating in the communications.

At block 705, a sensing matrix is processed using a set of one or more layers of the machine learning model to generate a set of associated sparse vector representations, wherein the machine learning model comprises a learned sparsifying dictionary, and a step size.

At block 710, a channel estimate is determined based on output of a final layer of the set of one or more layers of the machine learning model.

In some aspects, the method 700 further includes refining the learned sparsifying dictionary based on the channel estimate and a ground-truth channel state of the digital communication channel.

In some aspects, processing each respective layer of the set of one or more layers of the machine learning model comprises determining a residual value based on a current channel observation, the sensing matrix, the learned sparsifying dictionary, and a previous sparse vector representation; determining an update value based on the residual value, the sensing matrix, the learned sparsifying dictionary, and the step size; and determining a current sparse vector representation based on the previous sparse vector representation and the update value.

In some aspects, determining the residual value (r) is performed according to r=yᵢ−(ΦᵢΨ)zₜ₋₁, yᵢ is the current channel observation, Φᵢ is the sensing matrix, Ψ is the learned sparsifying dictionary, zₜ₋₁ is the previous sparse vector representation, t is a layer index, and i is an input sample index.

In some aspects, determining the update value (g) is performed according to g=γ(ΦᵢΨ)^{T}r, γ is the step size, Φᵢ is the sensing matrix, Ψ is the learned sparsifying dictionary, r is the residual value, and i is an input sample index.

In some aspects, determining the current sparse vector representation (zₜ) is performed according to zₜ=η_{θ}[zₜ₋₁+g], g is the update value, zₜ₋₁ is the previous sparse vector representation, n_{θ} is thresholding function, wherein θ is a learned threshold value, and t is a layer index.

In some aspects, determining the channel estimate (ĥ) based on the output of the final layer of the set of one or more layers of the machine learning model is performed according to ĥ=Ψz, Ψ is the learned sparsifying dictionary, z is the output of the final layer of the set of one or more layers.

In some aspects, the machine learning model comprises a set of learned sparsifying dictionaries, each respective learned sparsifying dictionary of the set of learned sparsifying dictionaries being associated with a respective layer of the set of one or more layers of the machine learning model.

In some aspects, the method 700 further includes receiving a transmitting device sparsifying dictionary component, and determining the learned sparsifying dictionary based on a receiving device sparsifying dictionary component and the transmitting device sparsifying dictionary component.

In some aspects, the machine learning model is configured to process communication channel data as a sparse vector representation in an angular domain, and the machine learning model uses a learned sparsifying dictionary, a sensing matrix, and the sparse vector representation.

In some aspects, the digital communication channel comprises a millimeter wave digital communications channel.

In some aspects, the method 700 further includes performing one of analog beamforming, beam selection, or spectral efficiency prediction based on the channel estimate.

### Example Channel Estimation Using Augmented Machine Learning Models

Generally, measurements represented by the sensing matrix Φ may change across different measurement scenarios. However, when a machine learning model is trained and deployed to generate sparse vector representations from which estimates of a channel can be generated, the various weights and parameters defining the model may be fixed. Thus, the model may not be adaptable to measurement scenarios that are different from those included in the training data set(s) used to train the machine learning model and may have poor inference performance (e.g., may generate a predicted or estimated channel state that is substantially different from an actual channel state) in these measurement scenarios.

To allow a machine learning model to accurately generate sparse vector representations from which channel estimates can be generated in a variety of operating environments, aspects of the present disclosure can augment a vector-representation-generating machine learning model trained to generate these sparse vector representations (e.g., as discussed above with respect to FIGS. 2 through 7) with a further machine learning model that may be trained to generate adaptation parameters that can be provided as input into the vector-representation-generating machine learning model. The generated adaptation parameters are used by the vector-representation-generating machine learning model in generating sparse vector representations from which a channel estimate can be generated. Collectively, the two models trained and deployed together are referred to herein as an “augmented machine learning model.”

In a given layer of a machine learning model using a fixed sensing matrix Φ and a sparsifying dictionary Ψ, the mutual coherence term \tilde{μ}, generalized mutual coherence term \tilde{μ}₂, and the restricted isometry property (RIP) constant δ(γ) may be defined. The mutual coherence term \tilde{μ} may be represented by the following expression:

$$\tilde{μ} := {max}_{1 \leq i \neq j \leq N} \vert {( {ΦΨ}_{t} )}_{i} {)}^{T} {( {ΦΨ}_{t} )}_{j} \vert$$

where Φ represents a fixed sensing matrix and Ψₜ represents the learned dictionary.

The generalized mutual coherence term \tilde{μ}₂ may be represented by the expression below:

$${\tilde{μ}}_{2} := {max}_{1 \leq i \neq j \leq N} \vert {( {ΦΨ}_{t} )}_{i} {)}^{T} {( Φ ( {Ψ}_{t} - {Ψ}_{0} ) )}_{j} \vert$$

where Ψ₀ represents a ground-truth dictionary.

Finally, the RIP constant δ(γ) may be represented by the following expression:

$$δ ( γ ) := {max}_{i} \vert 1 - γ {‖ {( {ΦΨ}_{t} )}_{i} ‖}_{2}^{2} \vert$$

Generally, in order to reduce the error at each step of training the machine learning model, (δ(γₜ)+γₜ\tilde{μ}(|S|−1) should be smaller than one. For a given layer t of a machine learning model trained to generate sparse vector representations, adaptation parameters including θₜ (the threshold parameter) and γₜ (the step size parameter), amongst other adaptation parameters, may play a significant role in allowing the machine learning model to converge upon a stable error or loss measurement. Generally, decreasing γ may support selection of a term, but can increase δ(γₜ) for a fixed value of θₜ.

As discussed, using fixed values for these adaptation parameters may not allow for a model to accurately predict sparsified vectors from which a channel estimate may be generated, as changes in Φ relative to the Φ used to train the machine learning model may result in a situation in which fixed, unique values of θ and γ are inapplicable for the different values of Φ that the model may encounter. By using another machine learning model to generate adaptation parameters, the machine learning model trained to generate the sparse vector representations can adapt to changes in a sensing matrix Φ so that the combined (augmented) machine learning model can accurately generate sparsified vectors for any sensing matrix Φ. Thus, the augmented machine learning model may be able to accurately perform channel estimation in a variety of scenarios or operating environments in which a device on which the augmented machine learning model executes is deployed.

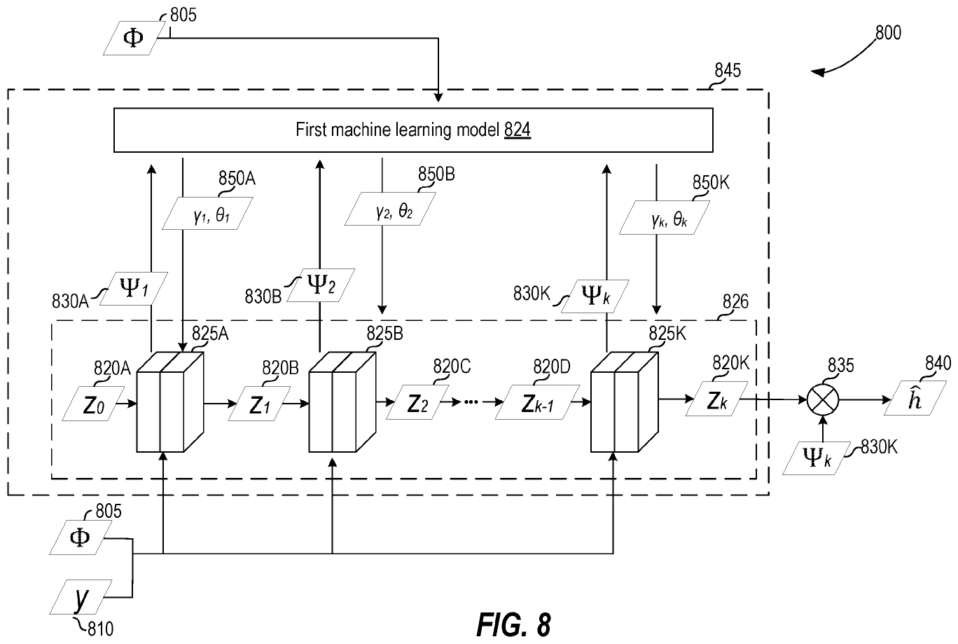

FIG. 8 depicts an example workflow 800 to perform channel estimation using a trained augmented machine learning model 845, which may include two or more machine learning models trained together and/or deployed together. The workflow 800 may be performed by a base station or a UE participating in a wireless communications system (e.g., by the receiver 115 of FIG. 1 and/or by a device or system that includes or uses the receiver 115).

The workflow 800 generally uses the trained augmented machine learning model 845 to generate a channel estimate 840 based, at least in part, on a channel observation 810 and a corresponding sensing matrix 805. As discussed above, the channel observation 810 generally corresponds to the signal perceived by a receiver (e.g., the receiver 115 of FIG. 1), and the sensing matrix 805 is generally defined based on the beamforming codebooks used by the transmitter and receiver when the signal was observed.

Similar to the description of FIG. 3, the augmented machine learning model 845 can process the channel observation 810 and the sensing matrix 805 to generate a sparse representation 820K (e.g., a sparse vector representation) of the wireless signal, and use the generated sparse representation 820K in conjunction with a final learned sparsifying dictionary 830K to generate the channel estimate 840 (e.g., via a multiplication operation 835).

As discussed above with reference to FIG. 3, in contrast with some approaches, the workflow 800 enables the sensing matrix 805 to differ or vary. That is, each channel observation 810 may have a corresponding sensing matrix 805, rather than using a fixed sensing matrix for all samples.

In the illustrated aspect, the workflow 800 includes processing the data using a first machine learning model 824 to generate adaptation parameters, which are in turn used by each layer 825 of a second machine learning model 826. In some aspects, the first machine learning model 824 may be implemented by a neural network.

The workflow 800 generates layer-specific adaptation parameters 850A, 850B, and 850K (collectively referred to herein as “layer-specific adaptation parameters 850”) that are used in processing each layer of the second machine learning model 826 (e.g., layers 825A, 825B, and 825K of the second machine learning model 826). In FIG. 8, the adaptation parameters 850 are depicted as a model step size γ and a model threshold size θ. However, in other aspects, the adaptation parameters 850 may include one, but not both, of γ and θ and may include additional parameters beyond γ and/or θ.

By using the first machine learning model 824 to generate the layer-specific adaptation parameters 850, the augmented machine learning model 845 as a whole becomes adaptive rather than static. That is, the adaptation parameters can be adjusted for different sensing matrices 805. Thus, the augmented machine learning model 845 can generate more accurate channel estimates 840 for a wider variety of channel observations 810 (e.g., captured in different environments).

The workflow 800 includes processing data via the second machine learning model 826 using a set of one or more layers 825A, 825B, and 825K. As discussed above, each layer 825 may be a layer of a neural network for implementing the second machine learning model 826. Although three layers are depicted in FIG. 8, in other aspects, the number of layers (also referred to as the number of iterations of the model) may differ. For example, in some aspects, a single layer 825 is used, and in other aspects, additional layers are used.

As illustrated in FIG. 8, the first layer of the second machine learning model 826 (e.g., the layer 825A) generates a learned sparsifying dictionary 830A (Ψ₁). The first machine learning model 824 processes the sensing matrix 805 in view of the learned sparsifying dictionary 830A to generate adaptation parameters 850A for the first layer of the second machine learning model 826. These adaptation parameters 850A are then processed by the layer 825A of the second machine learning model 826.

As a result of the processing, the layer 825A outputs an updated sparse representation 820B (e.g., using Equations (1), (2), and (3) discussed above). For example, as discussed above, the layer 825A may determine a residual value based on the channel observation 810, the sensing matrix 805, the sparsifying dictionary 830A, and the sparse representation 820A (e.g., using Equation (3) above). Similarly, the layer 825A may use the residual value, the sensing matrix 805, the sparsifying dictionary 830A, and a learned step size from the adaptation parameters 850A to generate an update value (e.g., using Equation (2) above). The layer 825A can then generate the updated sparse representation 820B based on the update value and the input sparse representation 820A. The layer 825A further uses a thresholding operation with a learned threshold portion of the adaptation parameters 850A generated by the first machine learning model 824, to generate the updated sparse representation 820B.

Similarly, the second layer of the second machine learning model 826 (e.g., layer 825B) generates a learned sparsifying dictionary 830B (Ψ₂). In various aspects, the sparsifying dictionary 830B may be the same as or different than the sparsifying dictionary 830A. The first machine learning model 824 processes the sensing matrix 805 in view of the sparsifying dictionary 830B to generate adaptation parameters 850B for the second layer of the second machine learning model. These adaptation parameters 850B are then utilized by the layer 825B, along with the sensing matrix 805 and the channel observation 810, to process the sparse representation 820B to generate an updated sparse representation 820C. The process continues for K iterations through the workflow through the final layer of the second machine learning model 826, until the channel estimate 840 is generated by the second machine learning model 826.

In some aspects, the layers 825 in the first machine learning model may be represented by the following equation:

$${z}^{t} = {η}_{{θ}_{( {Φ}_{i} {ψ}^{t} )}^{t}} \{ {z}^{t - 1} + {{γ}_{( {Φ}_{i} {ψ}^{t} )}^{t} ( ( {Φ}_{i} {ψ}^{t} ) )}^{T} [ {y}_{i} - ( {Φ}_{i} {ψ}^{t} ) {z}^{t - 1} \}$$

where t represents the current layer in the first machine learning model and t−1 represents a previous layer in the first machine learning model, such that the output z^{t-1} serves as an input into the t^{th} layer of the first machine learning model.

Meanwhile, layers of the augmented machine learning model may be represented by the expression below:

$$f ( {Φ}_{i} \cdot {ψ}^{t} ) \to \{ {θ}_{i}^{t} , {γ}_{i}^{t} \}$$

In some aspects, the machine learning models illustrated in FIG. 8 may use variational techniques to jointly solve the problems of learning a sparsifying dictionary Ψ and recovering a sparse representation z of a channel. In using variational techniques to solve these problems, the hypothesis that a ground truth dictionary exists may be relaxed. In such a case, the machine learning models may include a conditional prior p_{ξ} component, a variational posterior q_{φ} component, and a likelihood model p_{Θ} component.

In some aspects, the conditional prior p_{ξ}(Ψₜ|Ψₜ₋₁) may be modelled as a Gaussian distribution with parameters conditioned on the previously sampled dictionary Ψₜ₋₁. The conditional prior p_{ξ} may be parameterized using a neural network, represented by the equation below:

$${f}_{ξ} ( \cdot ) = [ {f}_{{ξ}_{1}}^{μ} ∘ {g}_{{ξ}_{0}} ( \cdot ) , {f}_{{ξ}_{2}}^{{σ}^{2}} ∘ {g}_{{ξ}_{0}} ( \cdot ) ]$$

with trainable parameters ξ={ξ₀, ξ₁, ξ₂, . . . }. The architecture of the neural network f_{ξ} may include a shared convolutional block, followed by branches generating the mean and standard deviation of the Gaussian distribution. Thus, at any layer t in the machine learning model, the prior conditional distribution may be represented by the following equation:

$${p}_{ξ} ( {Ψ}_{t} \vert {Ψ}_{t - 1} ) = 𝒩 ( μ = {f}_{{ξ}_{1}}^{μ} ( {g}_{{ξ}_{0}} ( {Ψ}_{t - 1} ) ) ; {σ}^{2} = {f}_{{ξ}_{2}}^{{σ}^{2}} ( {g}_{{ξ}_{0}} ( {Ψ}_{t - 1} ) ) )$$

The design of the conditional prior p_{ξ} allows for the machine learning model to enforce dependency of the dictionary sampled at iteration t to the dictionary sampled at a previous iteration t−1. At t=1, however, because there may be no previously sampled dictionary, it may be assumed that the dictionary is a Gaussian distribution Ψ₀. Ultimately, the joint prior distribution over the dictionaries may be represented by the following equation:

$${p}_{ξ} ( {Ψ}_{1 : T} ) = p ( {Ψ}_{1} ) {\prod }_{t = 2}^{T} {p}_{ξ} ( {Ψ}_{t} \vert {Ψ}_{t - 1} ) = 𝒩 ( μ = 0 ; {σ}^{2} = 1 ) {\prod }_{t = 2}^{T} N ( {μ}_{t} = {f}_{{ξ}_{1}}^{μ} ( {g}_{{ξ}_{0}} ( {Ψ}_{t - 1} ) ) ; {σ}_{t}^{2} = {f}_{{ξ}_{2}}^{{σ}^{2}} ( {g}_{{ξ}_{0}} ( {Ψ}_{t - 1} ) )$$

The variational posterior q_{φ}, like the conditional prior p_{ξ}, may also be modeled as a Gaussian distribution. The variational posterior q_{φ} may be parameterized by a neural network, represented by the equation below:

$${f}_{ϕ} ( \cdot ) = [ {f}_{{ϕ}_{1}}^{μ} ∘ {h}_{{ϕ}_{0}} ( \cdot ) , {f}_{{ϕ}_{2}}^{{σ}^{2}} ∘ {h}_{{ϕ}_{0}} ( \cdot ) ]$$

which outputs the mean and variance for the underlying probability distribution represented by the equation below:

$${q}_{ϕ} ( {Ψ}_{r} \vert {\hat{x}}_{t - 1} , y , Φ ) = 𝒩 ( μ = {f}_{{ϕ}_{1}}^{μ} ( {h}_{{ϕ}_{0}} ( {\hat{x}}_{t - 1} , y , Φ ) ) ; {σ}^{2} = {f}_{{ϕ}_{2}}^{{σ}^{2}} ( {h}_{{ϕ}_{0}} ( {\hat{x}}_{t - 1} , y , Φ ) ) )$$

This posterior distribution may be conditioned on the input data {y, Φ} as well as the reconstructed signal at the previous layer, \hat{x}ₜ₋₁. Thus, the joint posterior probability over the dictionaries at each layer may be represented by the following equation:

$${q}_{ϕ} ( {Ψ}_{1 : T} \vert {\hat{x}}_{1 : T} , y , Φ ) = {\prod }_{t = 1}^{T} {q}_{ϕ} ( {Ψ}_{t} \vert {\hat{x}}_{t - 1} , y , Φ )$$

The likelihood model p_{Θ} generally allows for the likelihood distribution to be modelled as a Gaussian distribution parameterized by the output of an Augmented Dictionary Learned Iterative Shrinkage Thresholding Algorithm (A-DLISTA) block, such as the layers 825 illustrated in FIG. 8. In some aspects, the likelihood model can generate a mean vector for the Gaussian distribution, given that the standard deviation may be treated as a tunable hyperparameter. In such a case, the reconstructed sparse vector at a layer t of the machine learning model may be interpreted as the mean of the likelihood distribution, allowing the joint log-likelihood distribution to be formulated according to the equation below:

$$log {p}_{Θ} ( {\hat{x}}_{1 : T} \vert {Ψ}_{1 : t} , y , Φ ) = log {\prod }_{t = 1}^{T} 𝒩 ( {μ}_{t} = A - DLISTA ( {Ψ}_{1 : t} , y , Φ , Θ ) , {σ}_{t}^{2} = δ ) = {\sum }_{t = 1}^{T} N ( {μ}_{t} = A - DLISTA ( {Ψ}_{1 : t} , y , Φ , Θ ) , {σ}_{t}^{2} = δ )$$

where δ represents a hyperparameter of the network.

The conditional prior p_{ξ} component, the variational posterior q_{φ} component, and the likelihood model p_{Θ} component of the machine learning models discussed herein may be trained based on maximization of the Evidence Lower Bound (ELBO). The objective function for ELBO may be represented by the following equation:

$$ELBO = {\sum }_{t = 1}^{T} {𝔼}_{{Ψ}_{1 : t} ∼ {q}_{ϕ} ( {Ψ}_{1 : t} \vert y , Φ , {\hat{x}}_{0 : t - 1} )} [ log {p}_{Θ} ( {x}_{t} = {x}_{gt} \vert {Ψ}_{1 : t} , y , Φ ) ] - {\sum }_{t = 2}^{T} {𝔼}_{{Ψ}_{1 : t - 1} ∼ {q}_{ϕ} ( {Ψ}_{1 : t - 1} \vert y , Φ , {\hat{x}}_{t - 1} )} [ {D}_{KL} ( {q}_{ϕ} ( {Ψ}_{t} \vert y , Φ , {\hat{x}}_{t - 1} {‖}_{P ξ} ( {Ψ}_{t} \vert {Ψ}_{t - 1} ) ) ] - {D}_{KL} ( {q}_{ϕ} ( {Ψ}_{1} \vert {\hat{x}}_{0} ) ‖ {p}_{ξ} ( {Ψ}_{1} ) )$$

$$The {\sum }_{t = 1}^{T} {𝔼}_{{Ψ}_{1 : t ∼} {q}_{ϕ} ( {Ψ}_{1 : t} \vert y , Φ , {\hat{x}}_{0 : t - 1} )} [ log {p}_{Θ} ( {x}_{t} = {x}_{gt} \vert {Ψ}_{1 : t} , y , Φ ) ]$$

term represents the likelihood contribution, while the

$${\sum }_{t = 2}^{T} {𝔼}_{{Ψ}_{1 : t - {1}^{∼ {q}_{ϕ} ( {Ψ}_{1 : t - 1} \vert y , Φ , {\hat{x}}_{t - 1} )}}} [ {D}_{KL} ( {q}_{ϕ} ( {Ψ}_{t} \vert y , Φ , {\hat{x}}_{t - 1} {‖}_{P ξ} ( {Ψ}_{t} \vert {Ψ}_{t - 1} ) ) ]$$

and D_{KL}(q_{φ}(Ψ₁|\hat{x}₀)∥p_{ξ}(Ψ₁)) terms account for KL divergence.

In some aspects, the dictionary Ψ may be an adaptive dictionary, which may be generated via a machine learning model, such as the augmented machine learning model 845 illustrated in FIG. 8. In such a case, the dictionary Ψ can be decomposed according to

$${Ψ}_{T}^{transmitter} ⊗ {Ψ}_{T}^{receiver} , where {Ψ}_{T}^{transmitter}$$

is provided to the receiver by the transmitter device and

$${Ψ}_{T}^{receiver}$$

corresponds to the learned dictionary.

### Example Architecture for an Augmented Machine Learning Model

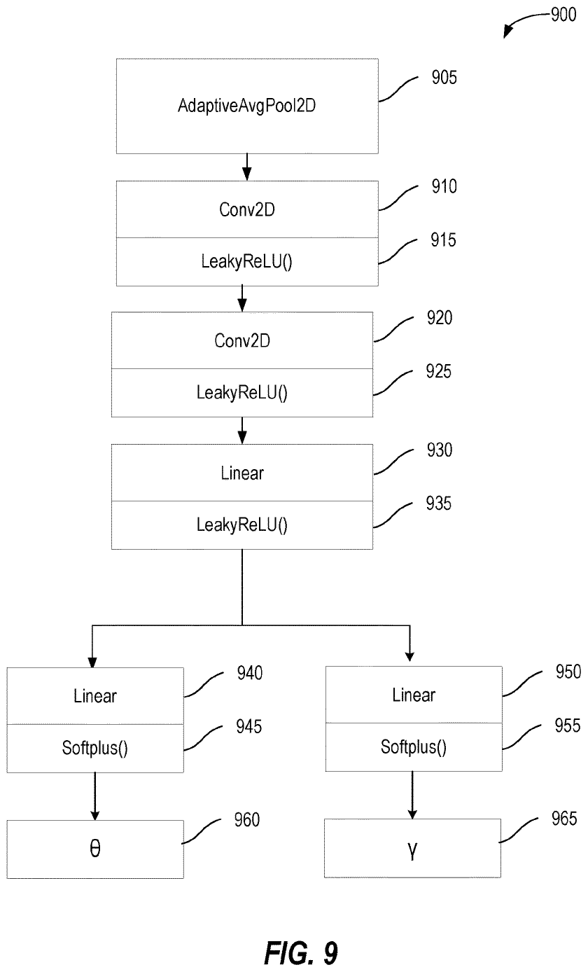

FIG. 9 depicts an example architecture 900 for a first machine learning model (e.g., the first machine learning model 824 of FIG. 8) of an augmented machine learning model (e.g., the augmented machine learning model 845 of FIG. 8), which may be a neural network in some aspects. The architecture 900 includes an adaptive average pooling layer 905, followed by convolutional layers 910 and 920 and a linear layer 930. The convolutional layers 910 and 920 and the linear layer 930 are linked with respective leaky value nonlinear activation functions 915, 925, and 935 (e.g., leaky rectified linear unit (ReLU) functions). From this architecture 900, two outputs are generated: one for each adaptation parameter. At one branch, a linear layer 940, combined with a softplus layer 945, is used to generate an adaptation parameter 960 (θ), which represents a model threshold. At another branch, a linear layer 950, combined with a softplus layer 955, is used to generate an adaptation parameter 965 (γ), which represents a model step size.

While the architecture 900 of FIG. 9 depicts these specific layers, in other implementations of the first machine learning model, there may be fewer or additional layers, and/or the layers may appear in a different order. Moreover, the architecture 900 can be adapted to output fewer or additional adaptation parameters than the adaptation parameter 960 and the adaptation parameter 965.

### Example Methods for Training Neurally Augmented Machine Learning Models for Channel Estimation

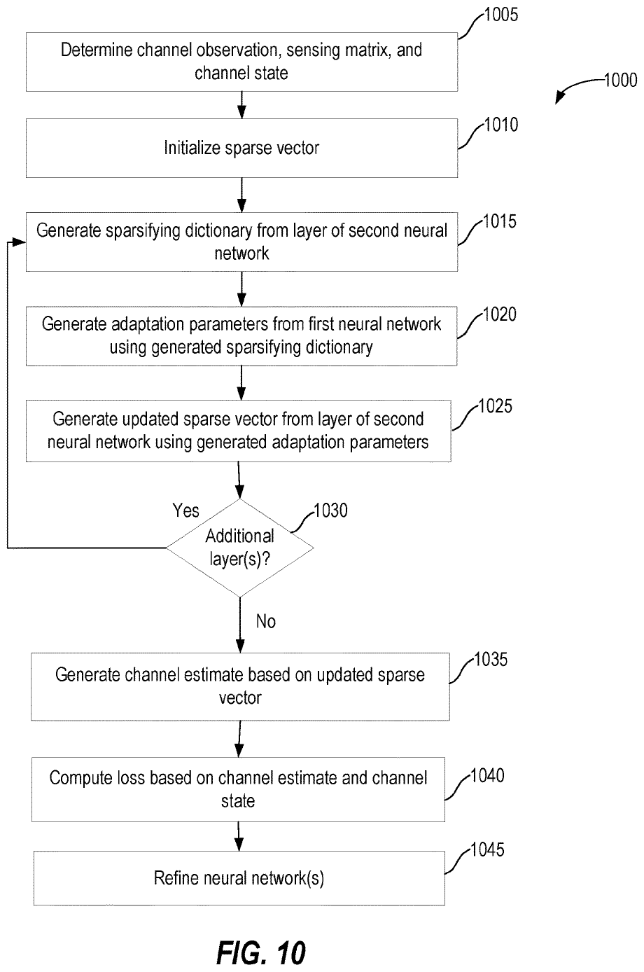

FIG. 10 is a flow diagram depicting an example method 1000 for supervised training of neurally augmented machine learning models for channel estimation. In some aspects, the method 1000 provides additional detail for the workflow 800 of FIG. 8. In some aspects, the method 1000 is performed to provide offline training of one or more machine learning models, such as by a training device or system.

At block 1005, the training system determines, identifies, receives, or otherwise accesses a training sample. In some aspects, the training sample may include one or more of a channel observation (e.g., the observation 210 of FIG. 2), a sensing matrix (e.g., the sensing matrix 205 of FIG. 2), and a channel state (e.g., the channel state 215 of FIG. 2). In some aspects, as discussed above, the channel observation corresponds to a wireless signal as observed or measured by a receiving device or system, the sensing matrix is defined based on the parameters used to transmit and/or receive the signal (e.g., the beamforming codebooks used by the transmitter and receiver), and the channel state corresponds to the properties of the wireless medium when the signal was transmitted.

In some aspects, the channel observation, sensing matrix, and/or channel state may generally be determined or received as part of a training sample or exemplar, as discussed above. By using such samples, the training system can iteratively refine the neurally augmented machine learning model to generate improved sparse representations of the wireless signal when provided new channel observations and sensing matrices. As discussed above, these sparse representations can in turn be used (alongside a learned sparsifying dictionary) to generate accurate channel estimates.

At block 1010, the training system trains the second machine learning model to initialize a sparse vector representation of the signal. For example, as discussed above, the training system can train the second machine learning model to initialize this first sparse vector representation with a value of zero (e.g., where all elements of the vector are zero). This may correspond, for example, to the sparse representation 220A of FIG. 2.

At block 1015, the training system trains the second machine learning model to generate a sparsifying dictionary. When the trained neurally augmented machine learning model is non-variational, this non-variational model may use a learned dictionary. That is, while training the model, each layer of the second machine learning model can be trained to generate the layer's own learned sparsifying dictionary. In other aspects, however, the training system can train the second machine learning model to generate a single learned sparsifying dictionary that is shared across all layers of the second machine learning model. In aspects where the trained neurally augmented machine learning model is a variational model, the model is trained to generate a sparsifying dictionary, and each layer of the second machine learning model generates the layer's own sparsifying dictionary.

At block 1020, the training system trains the first machine learning model to generate adaptation parameters using the generated learned sparsifying dictionary from block 1015. At block 1025, the training system trains the second machine learning model to generate an updated sparse representation (e.g., the sparse representation 220B of FIG. 2) using a layer (e.g., the first layer) of the second neural network model. For example, as discussed above, the training system can train the second machine learning model to process the initial or current sparse vector (initialized in block 1010), the channel observation, the learned adaptation parameters generated in block 1020, and the sensing matrix in order to generate an updated sparse representation.

In some aspects, block 1025 includes processing the data using trained parameters (e.g., a trained step size, a trained sparsifying dictionary, and/or a trained threshold), which may be unique to the current layer of the network, or may be shared across layers. In at least one aspect, the training system can train the second machine learning model to use Equations (1), (2), and (3), discussed in detail above, to generate the updated sparse vector. One example technique for performing block 1025 is described in more detail above with reference to FIG. 6.

At block 1030, the training system determines whether there is at least one additional layer remaining in the models. That is, the training system can determine whether the layer processed at block 1025 was the last or final layer of the second neural network. If there is at least one additional layer remaining in the second neural network, the method 1000 returns to block 1015, where the training system can train the second machine learning model to generate a new updated sparse vector. The new updated sparse vector is generated by processing the current vector (which was generated at block 1025 using the prior/initial sparse vector), and using the next layer of the second machine learning model. In this way, the method 1000 can proceed to process data through each layer of the model, iteratively refining or updating the sparse vector representation as each layer is passed.

If no further layers remain, the method 1000 continues to block 1035. At block 1035, the training system trains the second machine learning model to generate a channel estimate (e.g., the channel estimate 240 of FIG. 2) based on the most recent or current updated sparse channel representation that was generated by the final layer of the model (e.g., the sparse representation 220K of FIG. 2). For example, as discussed above, the training system may train the neurally augmented machine learning model to multiply the updated sparse vector with a trained sparsifying dictionary (e.g., the sparsifying dictionary 230 of FIG. 2) in order to generate the channel estimate.

At block 1040, the training system can then train the model to compute a loss based on the channel estimate (generated at block 1035) and the known channel state (determined at block 1005). For example, as discussed above, the model may be trained to compute the normalized mean squared error between the channel estimate and channel state. Although the illustrated example depicts generating the loss based on a single training sample (e.g., a single observation with corresponding sensing matrix and channel state), in some aspects, the training system can use batch training to generate a loss based on multiple samples.

At block 1045, the training system can then refine the first neural network model and/or layer(s) of the second neural network model based on the loss, as discussed above. For example, the training system may use backpropagation to refine the parameters of each layer, beginning with the final layer (or beginning with the final sparsifying dictionary used to generate the channel estimate) and moving towards the first. Generally, the method 1000 can be used to refine the two neural network models using any number and variety of training samples.

In some aspects, as discussed above, the training system can train or refine a separate set of parameters for each layer of the model. That is, each respective layer may have a respective learned step size, learned sparsifying dictionary, and/or learned threshold value. In such aspects, the training system can also use the loss to refine a final sparsifying dictionary used to generate the channel estimate, and/or refine the adaptation parameters.

By using the method 1000, the training system can train the model to generate significantly improved channel estimates, particularly for MIMO systems and/or systems using analog beamforming. Additionally, as discussed above, the trained model can generally use sparsifying dictionaries having lower dimensionality, as compared to some approaches, enabling the models to be used by devices or systems with more limited computational or power resources, such as user equipment.

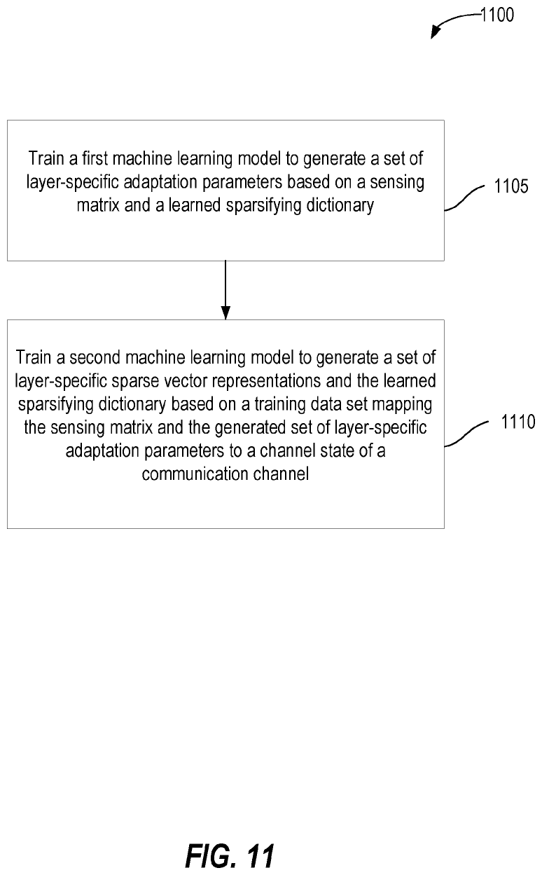

FIG. 11 is a flow diagram depicting an example method 1100 for supervised training of neurally augmented machine learning models for channel estimation. In some aspects, the method 1100 is performed to provide offline training of a neurally augmented machine learning model by a training device or system.

At block 1105, the training system trains a first machine learning model to generate a set of layer-specific adaptation parameters (e.g., the adaptation parameters 850 of FIG. 8) based on a sensing matrix (e.g., the sensing matrix 805 of FIG. 8) and a learned sparsifying dictionary (e.g., the sparsifying dictionary 830 of FIG. 8).

At block 1110, the training system trains a second machine learning model to generate a set of layer-specific sparse vector representations (e.g., the sparse representations 820 of FIG. 8) and the learned sparsifying dictionary based on a training data set mapping the sensing matrix and the generated set of layer-specific adaptation parameters to a channel state of a communication channel. Once trained, the first machine learning model and the second machine learning model may be collectively referred to as a trained neurally augmented machine learning model for channel estimation. While method 1100 depicts the flow as two discrete operations, in other aspects, the operations can be combined. That is, the training system trains the first machine learning model jointly with the second machine learning model, end to end.

In some aspects, the sensing matrix and channel state may generally be determined or received as part of a training sample or exemplar, as discussed above. By using such samples, the training system can iteratively refine the machine learning models to generate improved sparse representations of the wireless signal when provided new channel observations and sensing matrices. As discussed above, these sparse representations can in turn be used (alongside a learned sparsifying dictionary) to generate accurate channel estimates.

In some aspects, as discussed above, the training system can train or refine a separate set of parameters for each layer of the augmented machine learning model. That is, each respective layer may have a respective learned step size, learned sparsifying dictionary, and/or learned threshold value. In some aspects, when using the machine learning model together as discussed herein, an adaptation network is trained to generate the adaptation parameters. In other aspects, the training system can refine a learned step size, learned sparsifying dictionary, and/or learned threshold value.

By using the method 1000, the training system can train the model to generate significantly improved channel estimates, particularly for MIMO systems and/or systems using analog beamforming. Additionally, as discussed above, the trained model can generally use sparsifying dictionaries having lower dimensionality, as compared to some approaches, enabling the models to be used by devices or systems with more limited computational or power resources, such as user equipment.

### Example Method for Channel Estimation Using Augmented Machine Learning Models

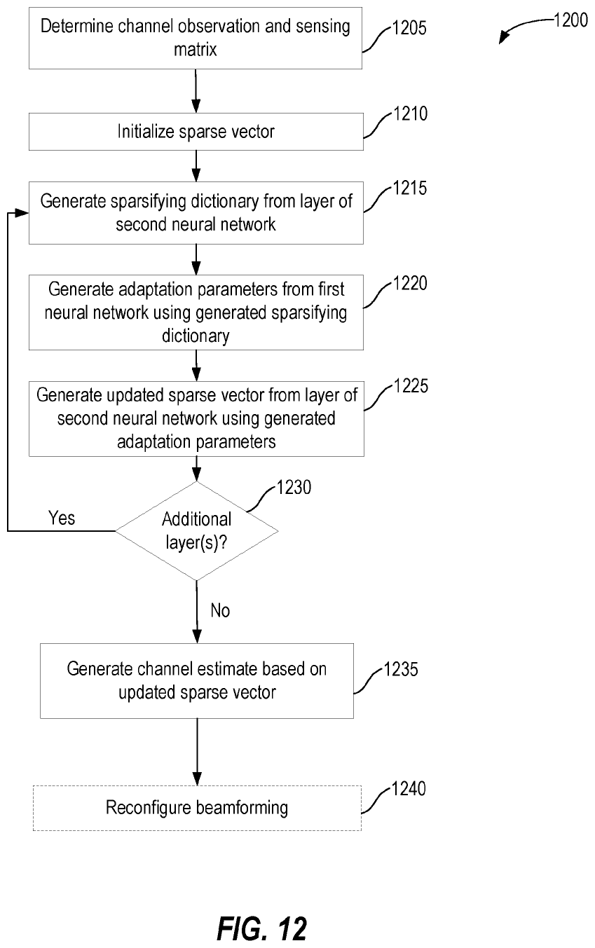

FIG. 12 is a flow diagram depicting an example method 1200 for performing channel estimation using machine learning models. The method 1200 may be based on the workflow 800 of FIG. 8. In some aspects, the method 1200 is performed by an inferencing device or system. In at least one aspect, the method 1200 is performed by a receiver participating in wireless communications. In some aspects, the method 1200 can additionally or alternatively be performed by a transmitter participating in the communications.

At block 1205, the inferencing system determines, identifies, receives, or otherwise accesses a data sample including a channel observation (e.g., the observation 810 of FIG. 8) and a sensing matrix (e.g., the sensing matrix 805 of FIG. 8). In some aspects, as discussed above, the channel observation corresponds to a wireless signal as observed or measured by a receiving device or system, and the sensing matrix is defined based on the parameters used to transmit and/or receive the signal (e.g., the beamforming codebooks used by the transmitter and receiver).

In some aspects, the channel observation and sensing matrix may generally be determined or received as part of a data sample for runtime processing, as discussed above. By evaluating such samples, the inferencing system can generate an accurate sparse representation of the wireless signal. As discussed above, this sparse representation can in turn be used (alongside a learned sparsifying dictionary included in the model) to generate accurate channel estimates.

At block 1210, the inferencing system initializes a sparse vector representation of the signal. For example, as discussed above, the inferencing system can initialize this first representation with a value of zero (e.g., where all elements of the vector are zero). This may correspond, for example, to the sparse representation 820A of FIG. 8.

At block 1215, the inferencing system generates a sparsifying dictionary (such as the dictionary 830A of FIG. 8) using a layer (e.g., the first layer) of a second neural network model (e.g., the second machine learning model 826 of FIG. 8). As discussed herein, when the model is not variational, the dictionary may be a trainable parameter for each layer. When the model is variational, the dictionary may not be a trainable parameter, and instead, the model learns to generate the dictionary for each layer. At block 1220, the inferencing system generates adaptation parameters (such as the adaptation parameters 850A of FIG. 8) using a first neural network model and the sparsifying dictionary generated at block 1215. As discussed herein, the adaptation parameters may be one or more of a step size, threshold, or another parameter for the neural network model.

At block 1225, the inferencing system generates an updated sparse vector (e.g., the sparse representation 820B of FIG. 8) using a layer (e.g., the first layer) of the second neural network model. For example, as discussed above, the inferencing system can process the initial or current sparse vector (initialized in block 1210), the channel observation, and the sensing matrix in order to generate an updated sparse vector representation. In some aspects, this includes processing the data using the adaptation parameters, which may be unique to the current layer of the network, or may be shared across multiple layers. In at least one aspect, the inferencing system can use Equations (1), (2), and (3), discussed in detail above, to generate the updated sparse vector. One example technique for performing block 1225 is described in more detail above with reference to FIG. 6.

At decision block 1230, the inferencing system determines whether there is at least one additional layer remaining in the model. That is, the inferencing system can determine whether the layer processed at block 1225 was the last or final layer. If there is at least one additional layer remaining, the method 1200 returns to block 1215, where the inferencing system can generate a new sparsifying dictionary from a layer of the second neural network. This sparsifying dictionary in turn is used in block 1220 to generate updated adaptation parameters from the first neural network. The updated adaptation parameters in turn are used in block 1225 to generate updated sparse vectors by processing the current vector (which was generated at block 1225 using the prior/initial sparse vector) using the next layer of the model. In this way, the method 1200 can proceed to process data through each layer of the augmented machine learning model, iteratively refining or updating the sparse vector representation as each layer is passed.

If no further layers remain as determined by decision block 1230, the method 1200 continues to block 1235. At block 1235, the inferencing system generates a channel estimate (e.g., the channel estimate 840 of FIG. 8) based on the most recent or current updated sparse channel representation that was generated by the final layer of the model (e.g., the sparse representation 820K of FIG. 8). For example, as discussed above, the inferencing system may multiply the updated sparse vector with a learned sparsifying dictionary (e.g., the sparsifying dictionary 830K of FIG. 8) in order to generate the channel estimate.

At block 1240, the inferencing can then optionally use the channel estimate to take one or more actions (e.g., to reconfigure, refine, or otherwise improve the wireless communications, such as by redefining the beamforming configuration). For example, as discussed above, the channel estimate can be used to inform or drive analog beamforming design, to enable faster and more accurate beam selection for the communication, and/or to provide improved spectral efficiency predictions.

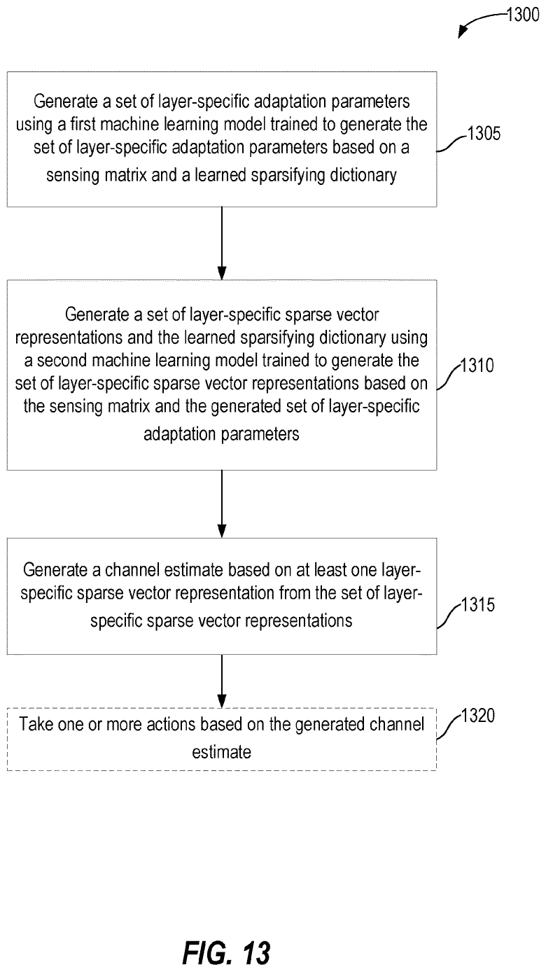

FIG. 13 is a flow diagram depicting an example method 1300 for performing channel estimation using an augmented machine learning model. In some aspects, the method 1300 provides additional detail for the workflow 800 of FIG. 8. In some aspects, the method 1300 is performed by an inferencing device or system. In at least one aspect, the method 1300 is performed by a receiver participating in wireless communications. In some aspects, the method 1300 can additionally or alternatively be performed by a transmitter participating in the communications.

At block 1305, the inferencing system generates a set of layer-specific adaptation parameters (e.g., the adaptation parameters 850 of FIG. 8) using a first machine learning model (e.g., the first machine learning model 824 of FIG. 8) trained to generate the set of layer-specific adaptation parameters based on a sensing matrix (e.g., the sensing matrix 805 of FIG. 8) and a learned sparsifying dictionary (e.g., the sparsifying dictionary 830 of FIG. 8).

In some aspects, as discussed above, the sensing matrix is defined based on the parameters used to transmit and/or receive the signal (e.g., the beamforming codebooks used by the transmitter and receiver). In some aspects, the sensing matrix may generally be determined or received as part of a data sample for runtime processing, as discussed above. By evaluating such samples, the inferencing system can generate an accurate sparse representation of the wireless signal. As discussed above, this sparse representation can in turn be used (alongside a learned sparsifying dictionary included in the model) to generate accurate channel estimates.

At block 1310, the inferencing system generates a set of layer-specific sparse vector representations (e.g., the sparse representations 820 of FIG. 8) and the learned sparsifying dictionary using a second machine learning model (e.g., the second machine learning model 826 of FIG. 8) trained to generate the set of layer-specific sparse vector representations based on the sensing matrix and the generated set of layer-specific adaptation parameters.

At block 1315, the inferencing system generates a channel estimate (e.g., the channel estimate 840 of FIG. 8) based on at least one layer-specific sparse vector representation from the set of layer-specific sparse vector representations. At block 1320, the inferencing system can optionally use the channel estimate to take one or more actions (e.g., to reconfigure, refine, or otherwise improve the wireless communications, such as by redefining the beamforming configuration). For example, as discussed above, the channel estimate can be used to inform or drive analog beamforming design, to enable faster and more accurate beam selection for the communication, and/or to provide improved spectral efficiency predictions.

### Example Processing System for Improved Channel Estimation

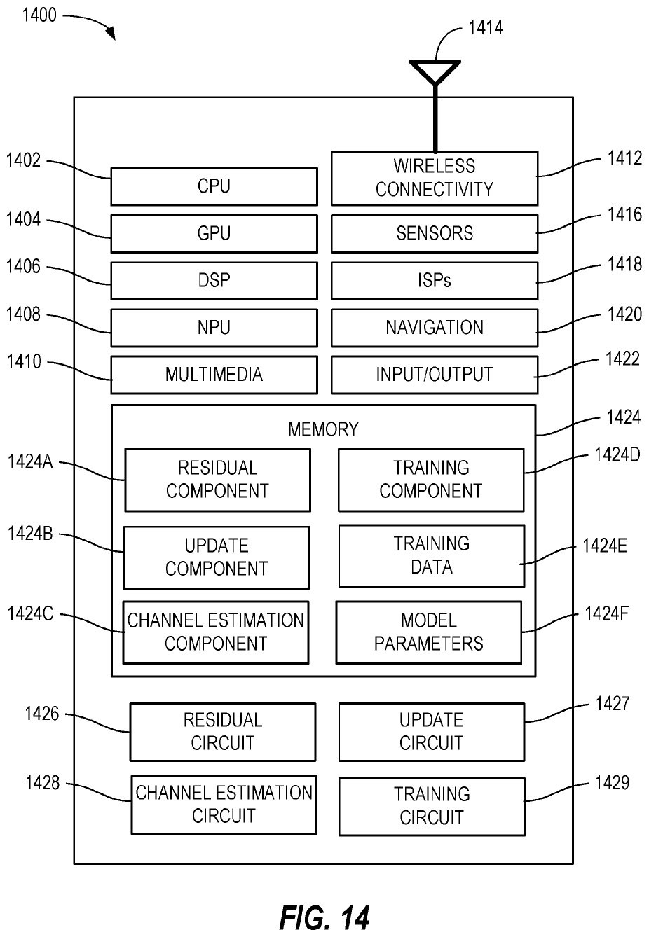

In some aspects, the workflows, techniques, and methods described with reference to FIGS. 1-13 may be implemented on one or more devices or systems. FIG. 14 depicts an example processing system 1400 configured to perform various aspects of the present disclosure, including, for example, the techniques and methods described with respect to FIGS. 1-13. In some aspects, the processing system 1400 may correspond to a computing system that trains machine learning models (e.g., a training system) and/or to a computing system that uses the trained models for inferencing (e.g., an inferencing system). In some aspects, the processing system 1400 corresponds to a base station and/or to user equipment engaged in wireless communication. Although depicted as a single system for conceptual clarity, in at least some aspects, as discussed above, the operations described below with respect to the processing system 1400 may be distributed across any number of devices. For example, a first system may train the model(s) while a second system uses the trained models to generate channel estimates (and take an action based thereon).

The processing system 1400 includes a central processing unit (CPU) 1402, which in some examples may be a multi-core CPU. Instructions executed at the CPU 1402 may be loaded, for example, from a program memory associated with the CPU 1402 or may be loaded from a memory partition (e.g., of memory 1424).

The processing system 1400 also includes additional processing components tailored to specific functions, such as a graphics processing unit (GPU) 1404, a digital signal processor (DSP) 1406, a neural processing unit (NPU) 1408, a multimedia processing unit 1410, and a wireless connectivity component 1412.

An NPU, such as the NPU 1408, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 1408, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and/or biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 1208 is a part of one or more of the CPU 1402, the GPU 1404, and/or the DSP 1406.

In some examples, the wireless connectivity component 1412 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and/or other wireless data transmission technologies. The wireless connectivity component 1412 is further coupled to one or more antennas 1414.

The processing system 1400 may also include one or more sensor processing units 1416 associated with any manner of sensor, one or more image signal processors (ISPs) 1418 associated with any manner of image sensor, and/or a navigation processor 1420, which may include satellite-based positioning system components (e.g., GPS or GLONASS) as well as inertial positioning system components.

The processing system 1400 may also include one or more input and/or output devices 1422, such as screens, touch-sensitive surfaces (including touch-sensitive displays), physical buttons, speakers, microphones, and the like.

In some examples, one or more of the processors of the processing system 1400 may be based on an ARM or RISC-V instruction set.

The processing system 1400 also includes the memory 1424, which is representative of one or more static and/or dynamic memories, such as a dynamic random access memory, a flash-based static memory, and the like. In this example, the memory 1424 includes computer-executable components, which may be executed by one or more of the aforementioned processors of the processing system 1400.

In particular, in this example, the memory 1424 includes a residual component 1424A, an update component 1424B, a channel estimation component 1424C, and a training component 1424D. The memory 1424 also includes a set of training data 1424E and model parameters 1424F. The model parameters 1424F may generally correspond to the parameters of all or a part of a machine learning model trained for channel estimation, such as one or more step sizes, one or more sparsifying dictionaries, and one or more threshold values used for one or more layers of a neural network, as discussed above. The training data 1424E generally corresponds to the training samples or exemplars discussed above, such as pairs of channel observations and sensing matrices (along with corresponding ground-truth channel states). The depicted components, and others not depicted, may be configured to perform various aspects of the techniques described herein. Though depicted as discrete components for conceptual clarity in FIG. 14, the residual component 1424A, the update component 1424B, the channel estimation component 1424C, and the training component 1424D may be collectively or individually implemented in various aspects.

The processing system 1400 further comprises residual circuit 1426, update circuit 1427, channel estimation circuit 1428, and training circuit 1429. The depicted circuits, and others not depicted, may be configured to perform various aspects of the techniques described herein.

For example, the residual component 1424A and the residual circuit 1426 may be used to generate residual values (e.g., using Equation (3) discussed above) as part of one or more layers of a neural network, as discussed above with reference to FIGS. 2-13. The update component 1424B and the update circuit 1427 may be used to generate update values and/or updated sparse vector representations (e.g., using Equations (1) and (2) discussed above) as part of one or more layers of a neural network, as discussed above with reference to FIGS. 2-13. The channel estimation component 1424C and the channel estimation circuit 1428 may be used to orchestrate the processing of data in the network and/or to generate the final channel estimation based on the output sparse vector representation (during training and/or during inferencing), as discussed above with reference to FIGS. 2-6. The training component 1424D and the training circuit 1429 may correspond to the training component 245 of FIG. 2, and may be used to compute losses and/or to refine the machine learning model, as discussed above with reference to FIGS. 2, 4, and 6.

Though depicted as separate components and circuits for clarity in FIG. 14, the residual circuit 1426, the update circuit 1427, the channel estimation circuit 1428, and the training circuit 1429 may collectively or individually be implemented in other processing devices of the processing system 1400, such as within the CPU 1402, the GPU 1404, the DSP 1406, the NPU 1408, and the like.

Generally, the processing system 1400 and/or components thereof may be configured to perform the methods described herein.

Notably, in other aspects, aspects of the processing system 1400 may be omitted, such as where the processing system 1400 is a server computer or the like. For example, the multimedia processing unit 1410, the wireless connectivity component 1412, the sensor processing units 1416, the ISPs 1418, and/or the navigation processor 1420 may be omitted in other aspects. Further, aspects of the processing system 1400 maybe distributed between multiple devices.

### EXAMPLE CLAUSES

Implementation examples are described in the following numbered clauses:

Clause 1: A processor-implemented method comprising: generating a set of layer-specific adaptation parameters using a first machine learning model trained to generate the set of layer-specific adaptation parameters based on a sensing matrix and a learned sparsifying dictionary; generating a set of layer-specific sparse vector representations and the learned sparsifying dictionary using a second machine learning model trained to generate the set of layer-specific sparse vector representations based on the sensing matrix and the generated set of layer-specific adaptation parameters; generating a channel estimate based on at least one layer-specific sparse vector representation from the set of layer-specific sparse vector representations; and taking one or more actions based on the generated channel estimate.

Clause 2: A method according to Clause 1, wherein the layer-specific adaptation parameters comprise one or more of a step size parameter or a threshold parameter.

Clause 3: A method according to Clause 1 or 2, wherein the learned sparsifying dictionary comprises a layer-specific dictionary.

Clause 4: A method according to Clause 1 or 2, wherein the learned sparsifying dictionary comprises a layer-agnostic dictionary shared across one or more layers of the first machine learning model.

Clause 5: A method according to any of Clauses 1-4, wherein the second machine learning model comprises a Dictionary Learned Iterative Shrinkage Thresholding Algorithm (DLISTA) model.

Clause 6: A method according to any of Clauses 1-5, wherein generating the learned sparsifying dictionary comprises generating a first portion of the sparsifying dictionary based on inputting a second portion of the sparsifying dictionary into the first machine learning model.

Clause 7: A method according to any of Clauses 1-6, wherein the first portion of the sparsifying dictionary comprises a receiver-specific portion of the sparsifying dictionary, and wherein the second portion of the sparsifying dictionary comprises a transmitter-specific portion of the sparsifying dictionary.

Clause 8: A processor-implemented method comprising: training a first machine learning model to generate a set of layer-specific adaptation parameters based on a sensing matrix and a learned sparsifying dictionary; and training a second machine learning model to generate a set of layer-specific sparse vector representations and the learned sparsifying dictionary based on a training data set mapping the sensing matrix and the generated set of layer-specific adaptation parameters to a channel state of a communication channel.

Clause 9: A method according to Clause 8, wherein the layer-specific adaptation parameters comprise one or more of a step size parameter or a threshold parameter.

Clause 10: A method according to any of Clauses 8-9, wherein the training the second machine learning model comprises: generating a residual value based on a current channel observation, the sensing matrix, the learned sparsifying dictionary, and a previous sparse vector representation; generating an update value based on the generated residual value, the sensing matrix, the learned sparsifying dictionary, and the layer-specific adaptation parameters; and generating a current sparse vector representation based on the previous sparse vector representation and the update value.

Clause 11: A method according to any of Clauses 8-10, wherein generating the residual value (r) is performed according to r=yᵢ−(ΦᵢΨ)zₜ₋₁, yᵢ is the current channel observation, Φᵢ is the sensing matrix, Ψ is the learned sparsifying dictionary, zₜ₋₁ is the previous sparse vector representation, t is a layer index, and i is an input sample index.

Clause 12: A method according to any of Clauses 8-11, wherein: generating the update value (g) is performed according to g=γ(ΦᵢΨ)^{T}r, γ is a step size portion of the layer-specific adaptation parameters, Φᵢ is the sensing matrix, Ψ is the learned sparsifying dictionary, r is the residual value, and i is an input sample index.

Clause 13: A method according to any one of Clauses 8-12, wherein: the second machine learning model is trained to generate the current sparse vector representation (zₜ) according to zₜ=n_{θ}[zₜ₋₁+g], g is the update value, zₜ₋₁ is the previous sparse vector representation, n_{θ} is thresholding function, wherein θ is a learned threshold value portion of the layer-specific adaptation parameters, and t is a layer index.

Clause 14: A method according to any of Clauses 8-13, further comprising: generating a channel estimate based on an output of the second machine learning model; and refining the second machine learning model based on the channel estimate and the channel state of the communication channel.

Clause 15: A method according to any of Clauses 8-14, wherein: generating the channel estimate (ĥ) based on the output of the second machine learning model is performed according to ĥ=Ψz, Ψ is the learned sparsifying dictionary, and z is the output of the second machine learning model.

Clause 16: A method according to any of Clauses 8-15, wherein the learned sparsifying dictionary is layer specific.

Clause 17: A method according to any of Clauses 8-16, further comprising receiving a transmitter sparsifying dictionary component, wherein training the second machine learning model to generate the learned sparsifying dictionary comprises training the second machine learning model to generate a receiver sparsifying dictionary component based on the transmitter sparsifying dictionary component.

Clause 18: A method according to any of Clauses 8-17, wherein the communication channel comprises a millimeter wave communication channel.

Clause 19: A processing system comprising: a memory having executable instructions stored thereon; and one or more processors configured to execute the executable instructions to cause the processing system to perform a method in accordance with any of Clauses 1-18.

Clause 20: A processing system comprising means for performing a method in accordance with any of Clauses 1-18.

Clause 21: A non-transitory computer-readable medium having instructions stored thereon which, when executed by a processor, cause the processor to perform a method in accordance with any of Clauses 1-18.

Clause 22: A computer program product embodied on a computer-readable storage medium comprising code for performing a method in accordance with any of Clauses 1-18.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A processor-implemented method, comprising:
generating a set of layer-specific adaptation parameters using a first machine learning model trained to generate the set of layer-specific adaptation parameters based on a sensing matrix and a learned sparsifying dictionary;
generating a set of layer-specific sparse vector representations and the learned sparsifying dictionary using a second machine learning model trained to generate the set of layer-specific sparse vector representations based on the sensing matrix and the generated set of layer-specific adaptation parameters;
generating a channel estimate based on at least one layer-specific sparse vector representation from the set of layer-specific sparse vector representations; and
taking one or more actions based on the generated channel estimate.

2. The method of claim 1, wherein the layer-specific adaptation parameters comprise one or more of a step size parameter or a threshold parameter.

3. The method of claim 1, wherein the learned sparsifying dictionary comprises a layer-specific dictionary.

4. The method of claim 1, wherein the learned sparsifying dictionary comprises a layer-agnostic dictionary shared across one or more layers of the first machine learning model.

5. The method of claim 1, wherein the second machine learning model comprises a Dictionary Learned Iterative Shrinkage Thresholding Algorithm (DLISTA) model.

6. The method of claim 1, wherein generating the learned sparsifying dictionary comprises generating a first portion of the sparsifying dictionary based on inputting a second portion of the sparsifying dictionary into the first machine learning model.

7. The method of claim 6, wherein:
the first portion of the sparsifying dictionary comprises a receiver-specific portion of the sparsifying dictionary, and
the second portion of the sparsifying dictionary comprises a transmitter specific portion of the sparsifying dictionary.

8. A processor-implemented method, comprising:
training a first machine learning model to generate a set of layer-specific adaptation parameters based on a sensing matrix and a learned sparsifying dictionary; and training a second machine learning model to generate a set of layer-specific sparse vector representations and the learned sparsifying dictionary based on a training data set mapping the sensing matrix and the generated set of layer-specific adaptation parameters to a channel state of a communication channel.

9. (canceled)

10. The method of claim 8, wherein the training the second machine learning model comprises:
generating a residual value based on a current channel observation, the sensing matrix, the learned sparsifying dictionary, and a previous sparse vector representation;
generating an update value based on the generated residual value, the sensing matrix, the learned sparsifying dictionary, and the layer-specific adaptation parameters; and
generating a current sparse vector representation based on the previous sparse vector representation and the update value.

11. The method of claim 10, wherein:
generating the residual value is performed according to r=yᵢ−(ΦᵢΨ)zₜ₋₁,
r is the residual value,
yᵢ is the current channel observation,
Φᵢ is the sensing matrix,
Ψ is the learned sparsifying dictionary,
zₜ₋₁ is the previous sparse vector representation,
t is a layer index, and
i is an input sample index.

12. The method of claim 10, wherein:
generating the update value is performed according to g=γ(ΦᵢΨ)^{T}r,
g is the update value,
γ is a step size portion of the layer-specific adaptation parameters,
Φᵢ is the sensing matrix,
Ψ is the learned sparsifying dictionary,
r is the residual value, and
i is an input sample index.

13. The method of claim 10, wherein:
the second machine learning model is trained to generate the current sparse vector representation according to zₜ=η_{θ}[zₜ₋₁+g],
zₜ is the current sparse vector representation,
g is the update value,
zₜ₋₁ is the previous sparse vector representation,
n_{θ} is a thresholding function,
θ is a learned threshold value portion of the layer-specific adaptation parameters, and
t is a layer index.

14. The method of claim 8, further comprising:
generating a channel estimate based on an output of the second machine learning model; and
refining the second machine learning model based on the channel estimate and the channel state of the communication channel.

15. The method of claim 14, wherein:
generating the channel estimate based on the output of the second machine learning model is performed according to ĥ=Ψz,
ĥ is the channel estimate,
Ψ is the learned sparsifying dictionary, and
z is the output of the second machine learning model.

16. (canceled)

17. The method of claim 8, further comprising receiving a transmitter sparsifying dictionary component, wherein training the second machine learning model to generate the learned sparsifying dictionary comprises training the second machine learning model to generate a receiver sparsifying dictionary component based on the transmitter sparsifying dictionary component.

18. (canceled)

19. A processing system, comprising:
a memory having executable instructions stored thereon; and at least one processor configured to execute the executable instructions to cause the processing system to:
generate a set of layer-specific adaptation parameters using a first machine learning model trained to generate the set of layer-specific adaptation parameters based on a sensing matrix and a learned sparsifying dictionary;
generate a set of layer-specific sparse vector representations and the learned sparsifying dictionary using a second machine learning model trained to generate the set of layer-specific sparse vector representations based on the sensing matrix and the generated set of layer-specific adaptation parameters;
generate a channel estimate based on at least one layer-specific sparse vector representation from the set of layer-specific sparse vector representations; and
take one or more actions based on the generated channel estimate.

20. The processing system of claim 19, wherein the layer-specific adaptation parameters comprise one or more of a step size parameter or a threshold parameter.

21. The processing system of claim 19, wherein the learned sparsifying dictionary comprises a layer-specific dictionary.

22. The processing system of claim 19, wherein to generate the learned sparsifying dictionary, the at least one processor is configured to cause the processing system to generate a first portion of the sparsifying dictionary based on an input of a second portion of the sparsifying dictionary into the first machine learning model.

23. The processing system of claim 22, wherein:
the first portion of the sparsifying dictionary comprises a receiver-specific portion of the sparsifying dictionary, and
the second portion of the sparsifying dictionary comprises a transmitter specific portion of the sparsifying dictionary.

24-30. (canceled)
